(19) United States
(12) Patent Application Publication
(10) Pub. No.: US 2006/0022983 A1
(43) Pub. Date: Feb. 2, 2006

(54) Processing three-dimensional data

(75) Inventors: Andre Gauthier, Quebec (CA); Patrick Foumier, Quebec (CA)

Correspondence Address: STAAS & HALSEY LLP, SUITE 700, 1201 NEW YORK AVENUE, N.W., WASHINGTON, DC, 20005, US

(73) Assignee: Alias Systems Corp., Toronto (CA)

(21) Appl. No.: 11/188,806

(22) Filed: Jul. 26, 2005

Related U.S. Application Data
(60) Provisional application No. 60/591,500, filed on Jul. 27, 2004.

(51) Int. Cl. G06T 15/70

(52) U.S. Cl. 345/473

(57) ABSTRACT

An apparatus for processing 3D data, including data storage, memory and processing. 3D data is stored in the memory means and the processing is configured to evaluate the 3D data with respect to a first function of time in a first evaluation mode and with respect to a second function of time in a second evaluation mode.

### BACKGROUND OF THE INVENTION

1. Field of the Invention

The present invention relates to processing 3D data in order to produce image data and in order to produce further 3D data.

2. Description of the Related Art

Animation applications that create and render three-dimensional animation data in order to produce two-dimensional image data are often used in order to create image data that would be difficult or expensive to create using real-life actors and objects, to create animated TV shows or movies or for use in computer games. However, although these applications are used to create effects that would be difficult using film, conversely editing operations that would be easy using film are difficult for an animator to produce. For example, in order to produce slow motion the animation of every object in a scene must be slowed down by exactly the same amount. Moving backwards and forwards in time or between scenes involves moving all the animation curves to the correct place. All this can be extremely time consuming for an animator, especially when a typical animation includes hundreds of objects.

### BRIEF SUMMARY OF THE INVENTION

According to an aspect of the present invention, there is provided apparatus for processing 3D data, comprising data storage means, memory means and processing means, wherein said 3D data is stored in said memory means and said processing means is configured to evaluate said 3D data with respect to a first function of time in a first evaluation mode and with respect to a second function of time in a second evaluation mode.

### BRIEF DESCRIPTION OF THE SEVERAL VIEWS OF THE DRAWINGS

FIG. 1 shows an example of a storyboard;

FIG. 2 illustrates a data processing system suitable for processing 3D data;

FIG. 3 details the components of the processing system shown in FIG. 2;

FIG. 4 details operations performed by the system illustrated in FIG. 3;

FIG. 5 illustrates the contents of the memory shon in FIG. 3;

FIG. 6 illustrates two timelines;

FIG. 7 shows time reference data shown in FIG. 4;

FIG. 8 details steps carried out during FIG. 4 to modify project data;

FIG. 9 illustrates the visual display unit shown in FIG. 2, displaying the interface of an animation application;

FIG. 10 details steps carried out during FIG. 8 to animate characters and objects;

FIG. 11 details steps carried out during FIG. 9 to add keyframes to an animation channel;

FIG. 12 details steps carried out during FIG. 11 to redisplay time markers;

FIG. 13 details steps carried out during FIG. 12 to obtain a current Action time;

FIG. 14 details steps carried out during FIG. 12 to obtain a current Edit time;

FIG. 15 details steps carried out during FIG. 11 to evaluate and display 3D data;

FIG. 16 details steps carried out during FIG. 8 to create shots;

FIG. 17 details steps carried out during FIG. 16 to modify the time reference data shown in FIG. 7 when a shot is created;

FIG. 18 details steps carried out during FIG. 16 to modify the time reference data shown in FIG. 7 when a shot is modified;

FIG. 19 details steps carried out during FIG. 18 to select relevant records in the time reference data shown in FIG. 7;

FIG. 20 illustrates the two timelines shown in FIG. 6 before modification of the shots;

FIG. 21 illustrates the two timelines shown in FIG. 20 after a first modification of the shots;

FIG. 22 illustrates the two timelines shown in FIG. 21 after a second modification of the shots;

FIG. 23 illustrates the two timelines shown in FIG. 21 after a third modification of the shots;

FIG. 24 details steps carried out during FIG. 8 to render 3D data;

FIG. 25 details steps carried out during FIG. 24 to render 3D data using the Action timeline;

FIG. 26 details steps carried out during FIG. 24 to render 3D data using the Edit timeline;

FIG. 27 illustrates the process shown in FIG. 24;

FIG. 28 details steps carried out during FIG. 4 to export data;

FIG. 29 details steps carried out during FIG. 28 to export 3D data;

FIG. 30 details steps carried out during FIG. 29 to simplify animation channels;

FIG. 31 details steps carried out during FIG. 29 to produce new animation curves;

FIG. 32 details steps carried out during FIG. 31 to copy keyframes to a new curve;

FIG. 33 details steps carried out during FIG. 31 to create start and finish keys in the new curve;

FIG. 34 details steps carried out during FIG. 29 to create a new camera;

FIG. 35 illustrates an example of the process shown in FIG. 29; and

FIG. 36 is a block diagram of the process illustrated in FIG. 35.

### WRITTEN DESCRIPTION OF THE BEST MODE FOR CARRYING OUT THE INVENTION

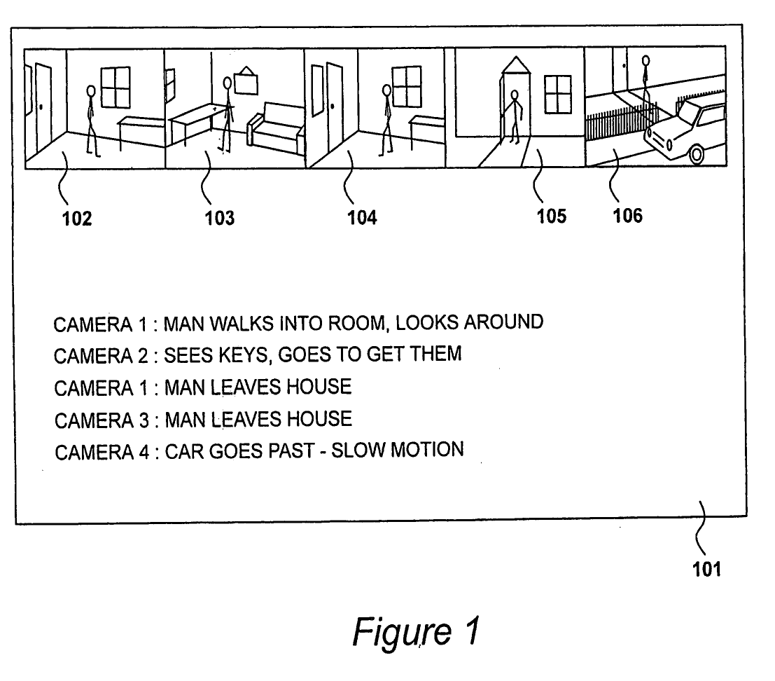

FIG. 1

Typically, the first stage in producing an animation is a story board, sketching the outline of a scene. FIG. 1 illustrates an example of such a storyboard 101. As explained in the accompanying text, in picture 102 a man walks into view in a room of a house and looks around. In picture 103 he sees his keys on a table and walks over to get them, these being seen from a different camera. In picture 104 he is shown leaving his house from the inside, while in picture 105 his exit is shown from a camera outside the house. In picture 106 he watches a car go past, shown from yet another camera, and this portion of the scene is to be in slow motion.

In order to animate such a scene an animator creates three-dimensional (3D) data. 3D data is a set of data that defines a number of assets, such as sets, objects and characters, and associates animation curves with some or all of them. An animation curve is a function over time that defines positions in space for a bone or vertex, or values for an attribute. When the 3D data is evaluated with respect to a particular time reference, image data, comprising a two-dimensional image, is produced, which can be viewed on display unit 202 or stored for later viewing. This is known as rendering.

Thus the animator creates the set, which includes the house and its furniture, garden path, garden fence and road. The man must be created as a character and then animated. The keys and the front door must be created as objects and constrained to the character's hand at certain times in order to allow the character to interact with them, and the car is created as an object and animated.

Getting all this right is a sophisticated task. However, finishing the scene is also not easy. Firstly, each of the different cameras must be set up such that they are turned on and off at specific times. Then the slow motion must be applied equally to the man, the car and the audio associated with each. Additionally, in order to make the opening of the front door realistic the animation of picture 104 must overlap slightly with that of picture 103, as a clean cut will look wrong to the viewer in the final Edit. Thus a small part of the animation must be repeated. In prior art systems this additional processing can be time-consuming.

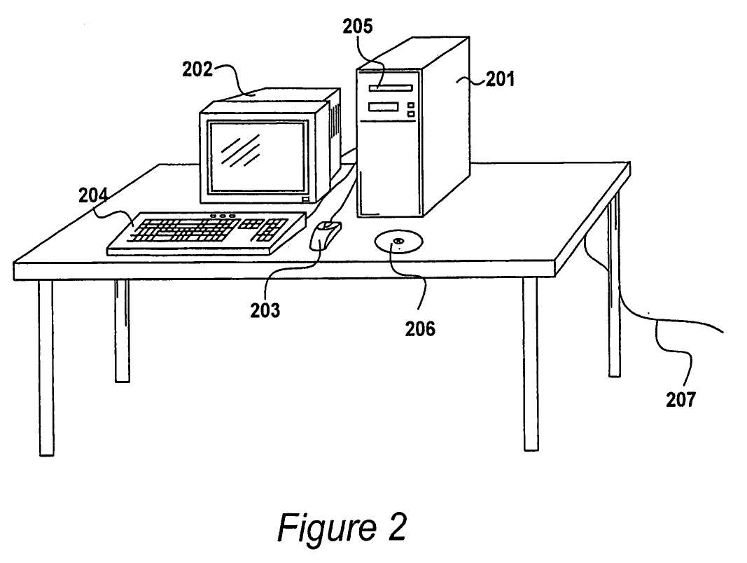

FIG. 2

An example of a data processing system suitable for creating and processing 3D data is shown in FIG. 2. The processing system includes a computer 201, a visual display unit 202, and manually-responsive input devices including a mouse 203 and a keyboard 204. Additional input devices could be included, such as stylus/touch tablet combinations and tracker balls etc. The programmable computer 201 is configured to execute program instructions read from memory. The computer system 201 includes a drive 205 for receiving CD-ROMs such as CD-ROM 206. Thus, image data generated by the processing system 201 may be stored locally, written to movable storage media, such as CD-ROM 206, or distributed via networks and/or the internet using network connection 209.

Programs executed by computer system 201 are configured to display a simulated three-dimensional world space to a user via the visual display unit 202. Within this world-space, assets required for the image data may be shown and may be manipulated within the world space. Input data is received, possibly via mouse 203, to create or load assets such as sets, objects and characters, provide animation for the characters and objects and view the animation.

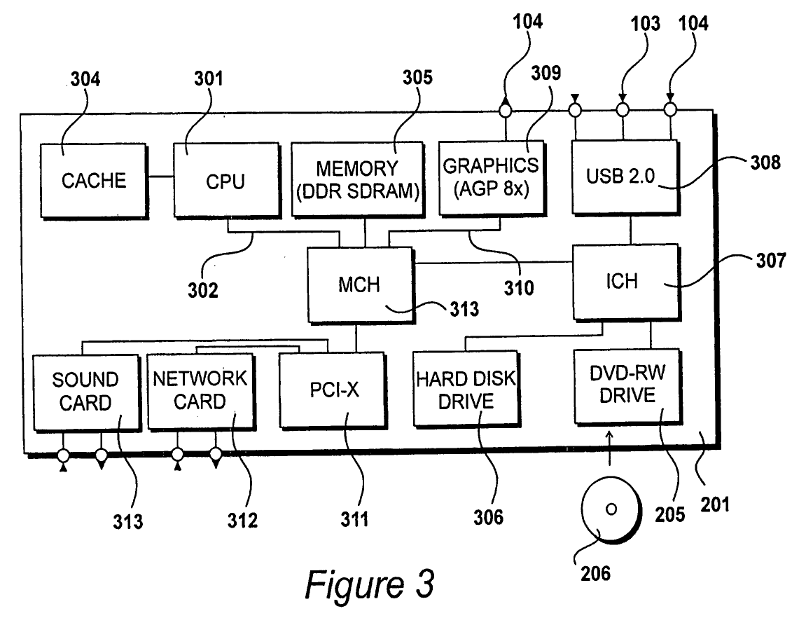

FIG. 3

Components of computer 201 are detailed in FIG. 3. IN this embodiment the equipment constitutes the components of a high-end PC compatible processing system. However, any suitable computer system could be used.

The system includes processing means provided by a central processing unit (CPU) 301, which fetches instructions for execution and manipulates data via a system bus 302 providing connectivity with Memory Controller Hub (MCH) 303. CPU 301 has a secondary cache 304 comprising 512 kilobytes of high speed static RAM for storing frequently-accessed instructions and data to reduce fetching operations from a larger main memory 305 via MCH 303. MCH 303 thus co-ordinates data and instruction flow with the main memory 305, which is at least one gigabyte in storage capacity, in this embodiment. Instructions and data are thus stored in memory means provided by main memory 305 and cache 304 for swift access by the CPU 301.

Storage means comprises a hard disk drive 306, providing non-volatile bulk storage of instructions and data via an Input/Output Controller Hub (ICH) 307. ICH 307 also provides connectivity to storage device 205. USB 2.0 interface 308 provides connectivity to manually-responsive input devices such as 103 and 104.

A graphics card 309 receives graphic data and instructions from CPU 301. Graphics card 309 is connected to MCH 303 by means of a high speed AGP graphics bus 310. A PCI interface 311 provides connections to a network card 312 that provides access to the network connection 209, over which instructions and or data may be transferred. A sound card 313 is also connected to the PCI interface 311 and receives sound data or instructions from the CPU 301.

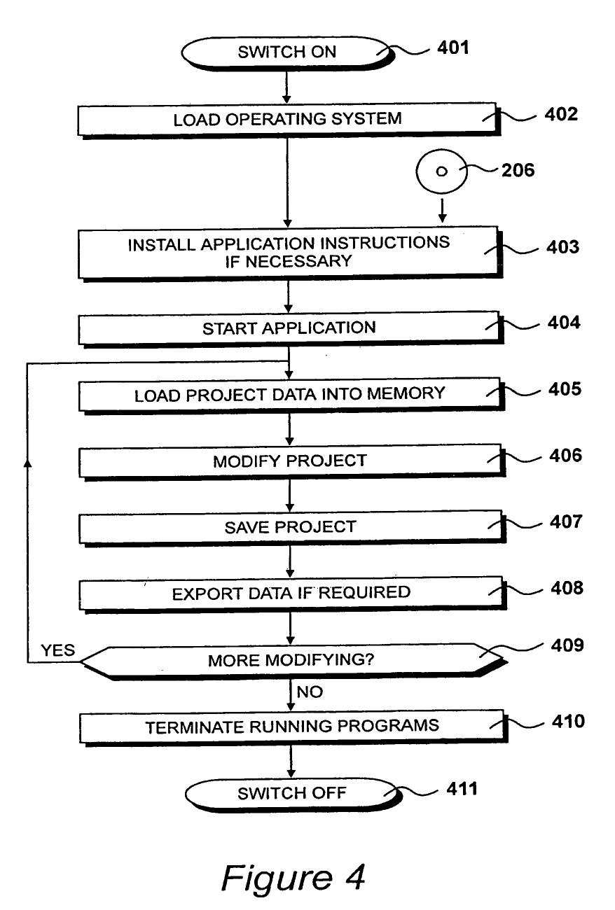

FIG. 4

Operations performed by the system illustrated in FIG. 3 are shown in FIG. 4. After starting operation at step 401, instructions defining an operating system are loaded at step 402. At step 403 instructions for the application of an embodiment are loaded if necessary from CD-ROM 206 and at step 404 the application is initialised.

At step 405 an existing project is loaded into memory from storage 306 if the user wishes to continue with an existing project; alternatively a new project is loaded. At step 406 the user modifies the project by creating and modifying 3D data, and at step 407 the project is saved. At step 408 data is exported if the project is finished—either as rendered image data or as 3D data—and at step 409 a question is asked as to whether there is another project to be modified. If this question is answered in the affirmative then control is returned to step 405 and another project is loaded. If, however, it is answered in the negative then at step 410 all running programs are terminated before the system shuts down at step 411.

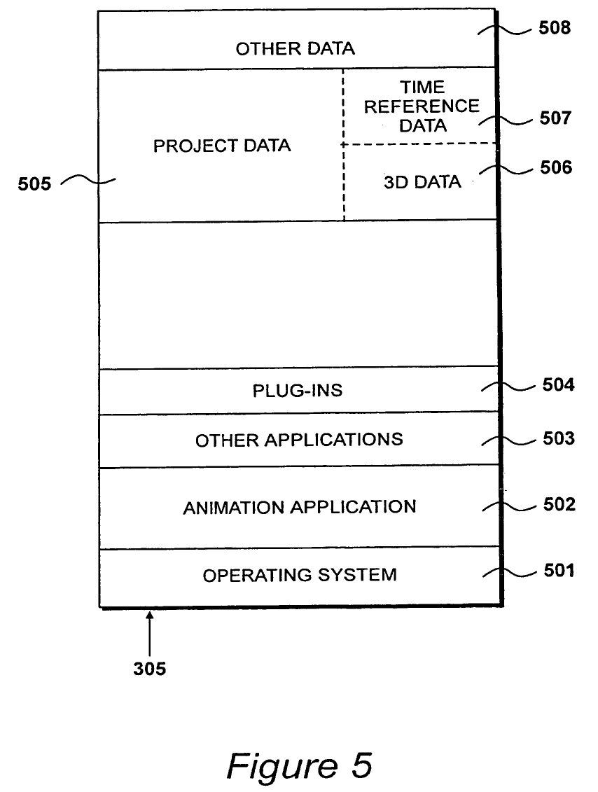

FIG. 5

The main memory 305 shown in FIG. 2 is detailed in FIG. 5. An operating system 501 provides operating system instructions for common system tasks and device abstraction. The Windows™ XP™ operating system is used. Alternatively, a Macintosh™, Unix™ or Linux™ operating system provides similar functionality. Animation application instructions 502 provide instructions for the creation, modification and rendering of three-dimensional object data. Other applications 503 provide common utilities such as internet access. Plug-ins 504 provide additional instructions for special effects used by the animation application 502 when performing rendering.

Project data 505 comprises 3D data 506, which includes data structures for the storage, animation and configuration of objects that are rendered and modified by the animation application instructions 502. These data structures include set, character and object definitions, animation curves, camera objects and lighting objects, video and audio files, lists of camera shots and so on. Project data 505 also includes time reference data 507, which is used by the animation application to provide a transformation between two different functions of time used in the application. Other data 508 includes temporary data structures used by the operating system 501 and other applications 503.

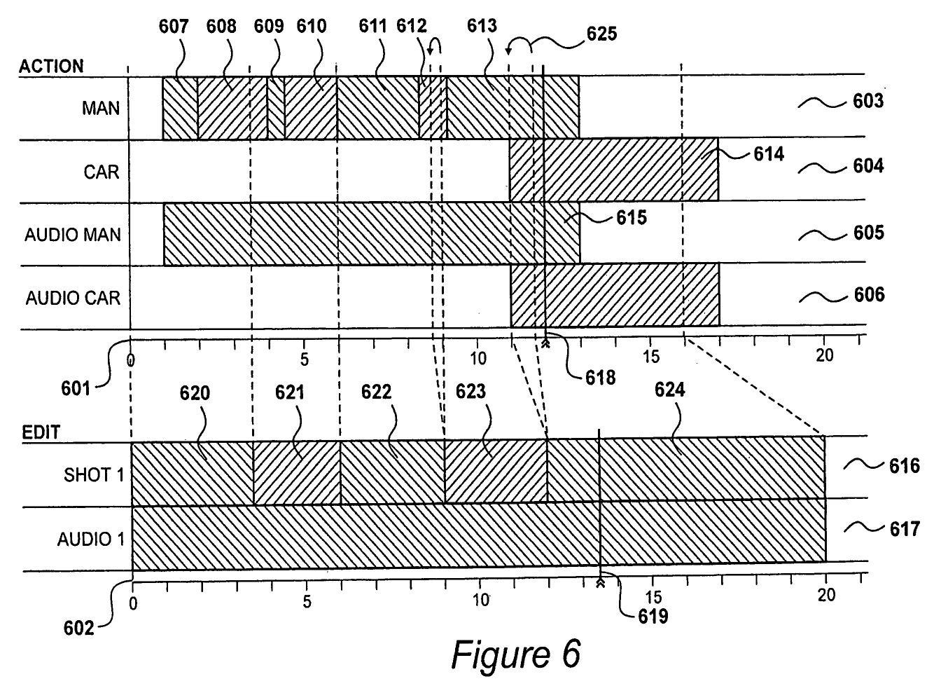

FIG. 6

The time consuming processes detailed with respect to FIG. 1, such as the addition of slow motion, the overlapping of animations and the timing of the cameras can all be considered as editing problems. Although the animation itself is complete, the way in which it is to be presented to the viewer still requires work. Thus animation application 502 provides two separate notions of time, an Action timeline 601 and an Edit timeline 602. Four animation channels are associated with Action timeline 601. Animation channel 603 contains animations for the man shown in storyboard 101, while channel 604 contains animations for the car. Channel 605 contains an audio file of footsteps for the man, while channel 606 contains an audio file of a car going past.

Channel 603 contains several animation curves. In FIG. 6 these are shown simply as blocks representing the amount of time they take up. However, in reality each animation curve consists of a number of keyframes. Each keyframe is defined by a time, a value, a type and other data fields which may vary according to the type. Thus, for example, if the animation is a Bezier curve then the keyframe will contain data fields for tangent in, tangent out and weight. Thus, given a time reference that falls between two keyframes, the application can interpolate between the values of these two keyframes according to the type of the keyframes and their additional data fields.

The type of value of a keyframe depends on the attribute or object that the animation curve is animating. Thus defining the amount of a particular attribute may require only a single number, defining a position on a plane requires two, while defining a position within 3D space requires three. Thus the nature of a keyframe varies according to the type of object and the type of animation being provided by the animation curve.

Thus the different animations in channel 603 comprise the man walking into the room at 607, stopping and looking around at 608, reacting to seeing his keys at 609, walking over to the table and picking up his keys at 610, walking to the front door at 611, opening the front door at 612, and walking down the garden path at 613. Channel 604 contains a single animation curve 614 of the car driving down the road.

The audio files shown in channel 605 and 606 are also keyframed. For example, file 615 in channel 605 has a keyframe at the beginning that starts playback of the file and a keyframe at the end that stops it. There may be further keyframes in between that vary the speed of playback to match the footsteps to the actual movement of the man.

In contrast, channels 616 and 617 associated with Edit timeline 602 contains no animation. Channel 616 contains blocks representing a number of shots. Each shot is defined by a start and an end time, a camera associated with the shot and possibly a video or audio file. Each of the five shots relates to one of the pictures shown in FIG. 1. Channel 617 contains a single shot that is linked to an audio file, such as music or a voiceover.

The two timelines 601 and 602 define two different functions of time within the application. Thus the time marker 618 on Action timeline 601 and time marker 619 on Edit timeline 602 refer to the same point in the animation, although they are at different times. Thus the use of Edit timeline 602 allows the user to perform Editing usually associated with an offline or online Editing suite, such as repeating animation, slow motion and camera switching, without altering the animation as defined with respect to Action timeline 601.

The dashed lines show the correspondences between the two timelines. Thus the first shot 620 runs from 0 to 3.5 seconds on Edit timeline 602 and shows the animation that also runs from 0 to 3.5 seconds on Action timeline 601, as seen through a particular camera. Shot 621 runs from 3.5 seconds to 6 seconds on Edit timeline 602, and shows the Action that runs from 3.5 to 6 seconds on Action timeline 601, but seen through a different camera. Shot 622 runs from 6 to 9 seconds on Edit timeline 602, and shows the animation that runs from 6 to 9 seconds in Action timeline 601.

Shot 623, however, although it runs from 9 seconds to 12 seconds in Edit timeline 602, shows the animation that runs from 8.7 to 11.7 seconds in Action timeline 601. Thus the repetition of the section of animation indicated by arrow 625 during the door-opening clip 612 is achieved without any actual copying of the 3D data. Adjustment of the size of the overlap is thus made extremely easy.

Shot 624 runs from 12 seconds to 20 seconds in Edit timeline 602, but shows the animation that runs from 11 seconds to 16 seconds in Action timeline 601. Thus, not only does the animation jump backwards by 0.7 seconds, it is also then stretched out to play back in slow motion. Again, this is achieved without any alteration of the animation. This ensures that the animations of the man and the car and their associated audio are all slowed down by exactly the same amount. The final second of animation is not played at all in Edit timeline 602.

The use of the two different timelines also makes the addition of voiceover or music very easy. Although the audio files in channels in 605 and 606, which are conceptually connected to the actual animation of the man and the car, are repeated and stretched in the same way, the audio in channel 617 is associated with the Edit timeline and thus plays smoothly over the top without being affected by these repetitions and stretching. Thus the application uses two variables, a current Action time and a current Edit time, but there may be more than one current Action time. Thus throughout this document when the current Action time is referred to it should be appreciated that the variable may take more than one value.

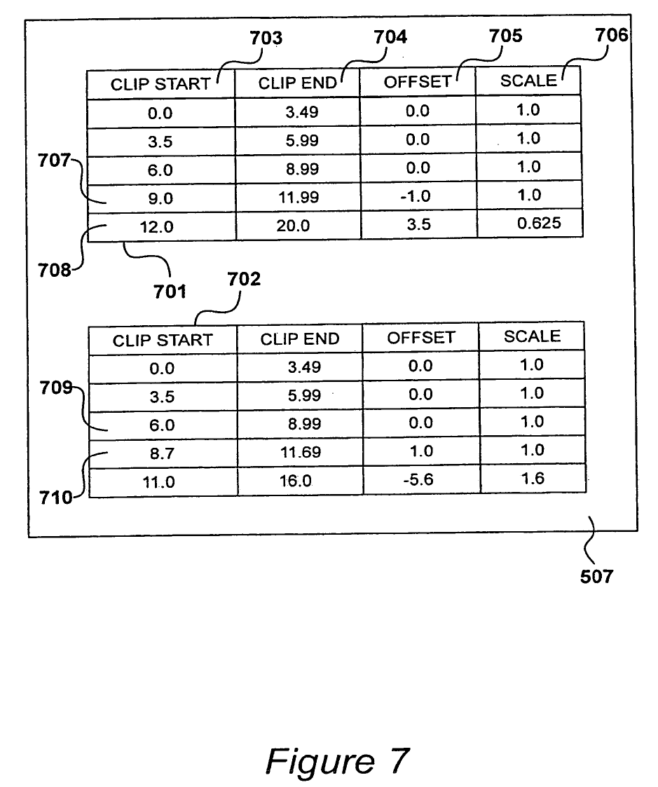

FIG. 7

FIG. 7 shows time reference data 507, which is in the form of two time reference tables 701 and 702. Forward time transformation table 501 has four columns. Column 703 gives the start of a shot in the Edit timeline, while column 704 gives the end of the shot. Column 705 gives an offset value and column 706 gives a scale value, both of which are used to calculate the Action time (ie the time according to Action timeline 601) corresponding to any given Edit time (ie the time according to Edit timeline 602). Thus, the first three rows each have an offset of 0 and a scale of 1, showing that from 0 to 9 seconds the Edit and Action times are identical. Row 706 shows that in the next shot the Action time is offset from the Edit time by −1, while row 707 shows that for the final shot an Edit time must be multiplied by a scale of 0.625 and then offset by 3.5 in order to obtain the correct Action time.

Backward time transformation table 702 gives the transformation necessary to take a time in Action timeline 601 to a corresponding time in Edit timeline 602. It contains the same four columns as forward transformation table 701. However, where in this example a time in the Edit timeline refers to a single Action time, a time in the Action timeline may refer to several Edit times. Thus the shot start and shot end values for the final three rows overlap. For example, an Action time of 8.8 seconds would correspond to an Edit time of 8.8 seconds using the transformation in row 1108. However, using the transformation in row 709, the same time also corresponds to an Edit time of 9.8 seconds. This is because the section of animation from 8.7 to 9 seconds is repeated.

Although it is not shown in this example, an Edit time may also refer to more than one Action time, since blending between shots can be achieved using the Edit timeline. Conceptually, when this occurs the Edit timeline is taking input from two different Action times and blending them, whereas an Action time that relates to two Edit times is providing input to create two different Edit times and therefore two different, although visually identical, pieces of animation data when the animation is played in Edit mode.

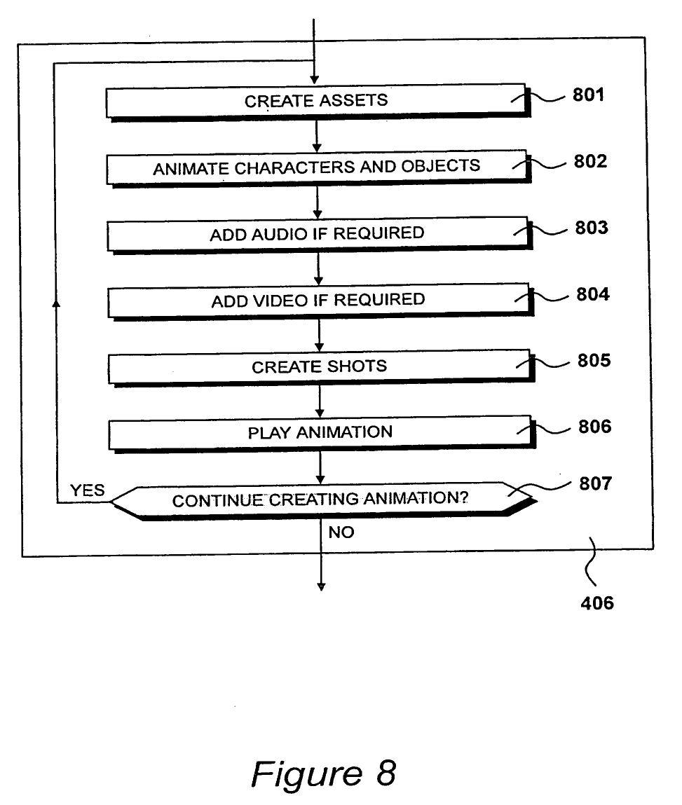

FIG. 8

FIG. 8 details steps 406 at which a project is modified. At step 801 assets are created if required, such as sets, characters, objects, cameras, lights, and so on. At step 802 characters and objects are animated if required, either by having existing animation applied to them, such as motion capture data or animation curves created during another project, or using a process known as keyframing in which the animator creates an animation curve by creating keyframes.

At step 803 audio files are added if required and at step 804 video files are added if required. An example of how video might be used in an application is as a background outside a window or as a scene playing on a television. Video data is any two-dimensional image data, whether animated or not, which is imported. It may, for example, have been created using an animation application, or it could be footage shot with a digital video camera or digitised from film.

At step 805 shots in the Edit timeline are created if required and at step 806 the animation thus created is played. At step 807 a question is asked as to whether the user wishes to continue modifying the project, and if this question is answered in the affirmative control is returned to step 801. If it is answered in the negative step 406 is concluded.

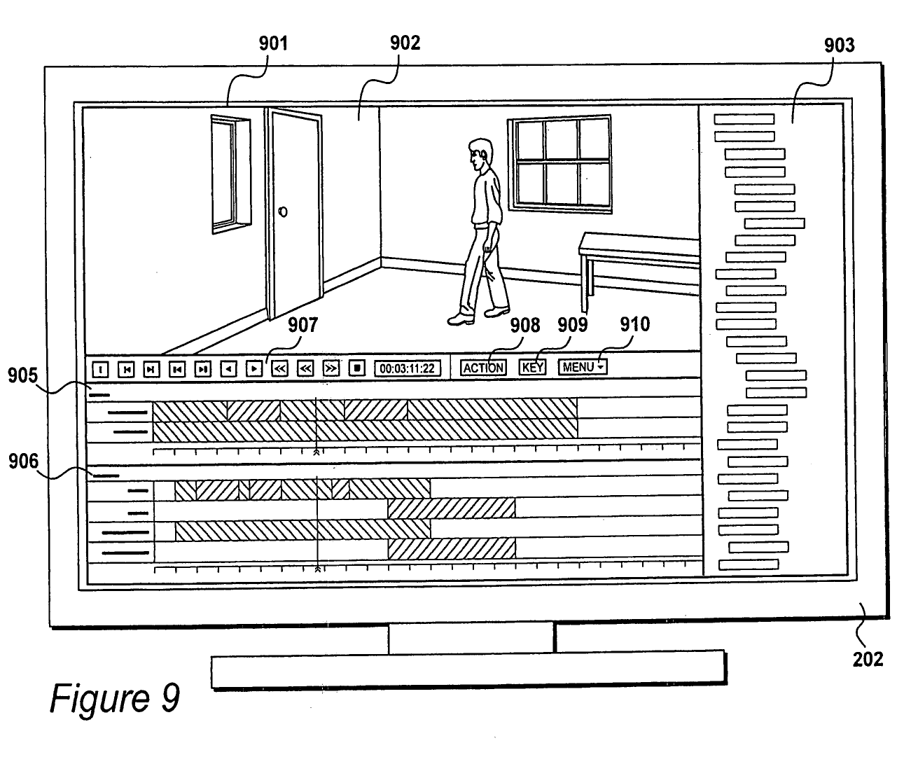

FIG. 9

FIG. 9 shows visual display unit 202 with the graphical user interface of animation application 505 displayed on it. The interface 901 consists of a viewer area 902, a browser 903, menu bar 904, Edit interface 905 and Action interface 906.

Action interface 906 includes Action timeline 601, the four Action channels 603 to 606, complete with their animation curves, and Action time marker 618. Edit interface includes Edit timeline 602, the Edit channels 616 and 617 and their associated shots, and Edit marker 619.

The animation, or image data, produced by evaluating the 3D data with respect to the time reference indicated by the position of Action marker 618 on Action timeline 601 is shown in viewer 902. The image data shown in the viewer may include images of many objects that do not have corresponding channels in the Action interface 906, such as the house, the garden, the road, the camera through which the scene is being viewed and the lights that are lighting it. This is because these objects are not animated; however, their definitions are part of 3D data 506 and thus their positions and appearances are calculated as part of the evaluation of the 3D data. It is, of course, possible to animate any object within a scene; a light may be animated to indicate the switching on or off of a light bulb or the movement of the sun, a camera may be animated in order to switch views or to pan, and so on.

Browser 903 contains a list of all assets which can be created and used in the animation. For example, it contains files that define basic actors and more complicated characters, household objects, sets, cameras and lights, and so on. When a user wishes to include such an object in his animation an instance of the required file is created and becomes a definition within 3D data 506. The browser 903 also includes more basic building blocks such as lines, two-dimensional and three-dimensional shapes and so on, allowing the user to build objects that are not already included in the asset browser. The browser 903 also includes files containing standard animation curves that may be applied to characters and objects.

Menu bar 904 includes transport controls 907 to play the animation, an Edit/Action switching button 908 which enables the user to switch between Action and Edit modes, a Key button 909 which facilitates the creating of keyframes, and menu button 910 which allows the user to access a variety of options, effects, plug-ins and other functions to improve the animation.

The interface and animation application described herein are provided as examples of how the invention may be embodied. However, the skilled reader will appreciate that the type of animation data used, the layout of the interface and the exact method of creating, modifying and rendering image data are not crucial to the invention. Animation application 502 is a simple application using only animation curves and constraints. However, other interfaces exist which produce animation in far more sophisticated ways. These could also be used in other embodiments of the invention.

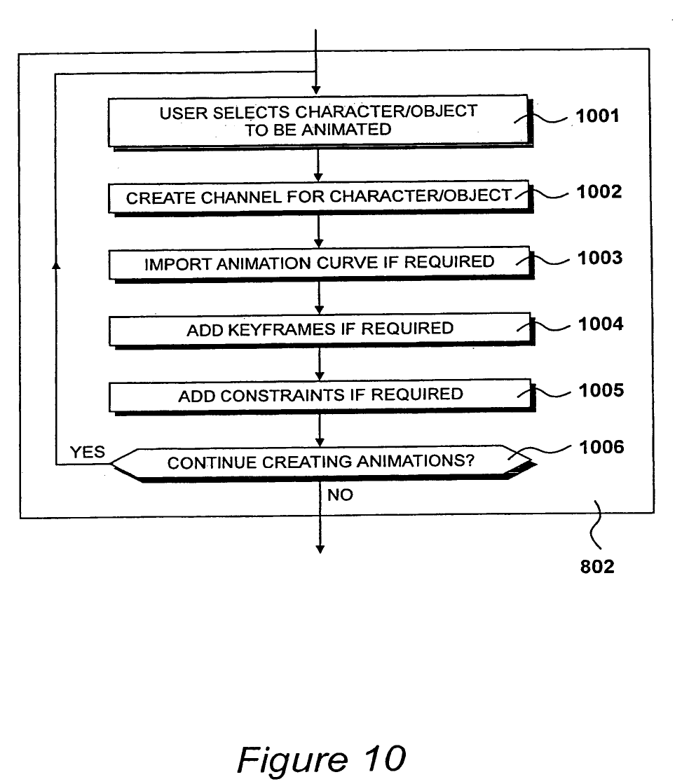

FIG. 10

FIG. 10 details step 802 at which the user animates characters and objects. At step 1001 the user selects a character or object to be animated and at step 1002 a channel associated with the Action timeline is created. At step 1003 an animation curve is imported if required and at step 1004 keyframes are added if required. The user may create animation using a combination of preset animation curves and keyframing, or using only one method.

At step 1005 constraints are added. Constraints are conditions placed on a part or whole of a character or object that are taken into account when evaluating an animation curve. A common constraint is that a character's feet may not pass through the floor, and thus even if an animation curve gives a position below the floor for a particular time reference, the constraint will not allow this to happen. Bones within an actor are constrained to each other such that when, for example, the hand is moved the rest of the arm also moves without having to be separately animated.

At step 1006 a question is asked as to whether the user wishes to continue animating and if this question is answered in the affirmative control is returned to step 1001. If it is answered in the negative then step 802 is concluded.

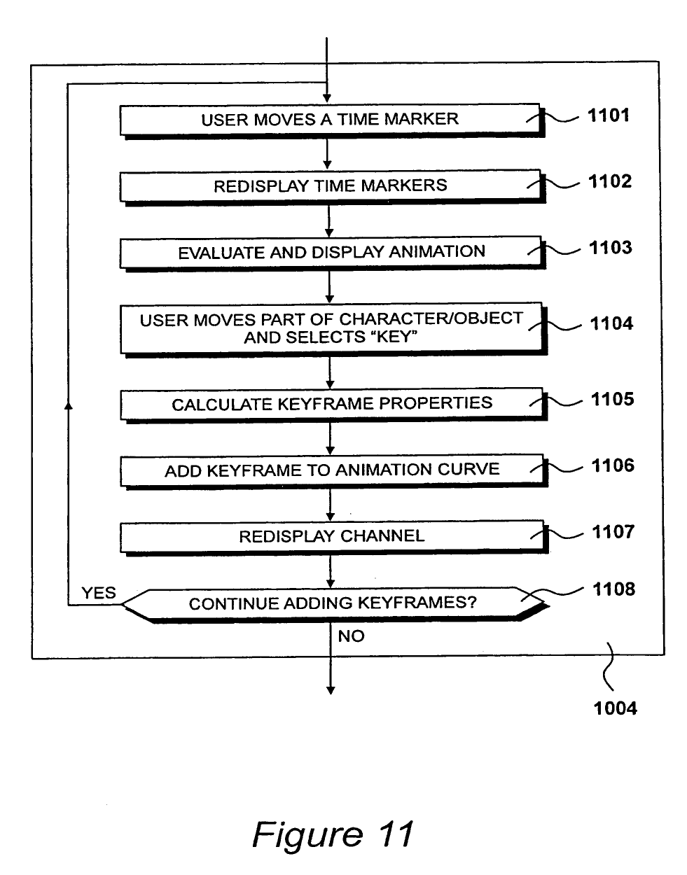

FIG. 11

FIG. 11 details step 904 at which the user adds keyframes to an animation channel. At step 1101 the user moves a time marker in order to set the time at which the keyframe will be inserted. Although keyframes are specified with regard to time in Action, the user may move the Edit marker 619 instead of the Action marker 618 in order to indicate the time at which the key should be inserted. Since movement of either marker will cause movement of the other, at step 1102 both time markers are re-displayed, while at step 1103 the 3D data contained within the project is evaluated with respect to the time to which the Action marker 618 has been moved (whether this movement was caused directly by movement of Action marker 618 or indirectly by the movement of Edit marker 619) and the image data thus produced is displayed.

At step 1104 the user moves a part of the character or object to a desired position ands then selects Key button 909. At step 1105 the properties of the new keyframe are calculated, including the value the keyframe should take based on the changes made by the user at step 1004, and the values that the data field should take, such as the tangent in and out values. At step 1106 a keyframe having these properties and also having the time specified by the movement of Action marker 618 is inserted in the animation curve in the character or object channel. At step 1107 this channel is re-displayed so that the user can see the new keyframe.

At step 1108 a question is asked as to whether there is another keyframe to add and if this question is answered in the affirmative control is returned to step 1101. If it is answered in the negative then step 1004 is concluded.

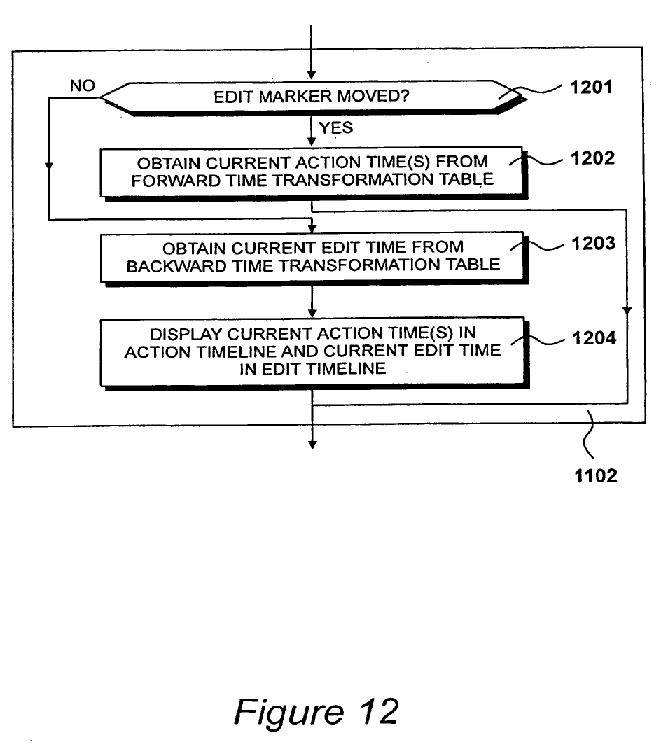

FIG. 12

FIG. 12 details step 1102 at which time markers 618 and 619 are redisplayed. At step 1201 the question is asked as to whether it is Edit time marker 619 that has been moved. At any point, the application is considered to be either in an Action mode or an Edit mode, and some modifications within each of interfaces 905 and 906 can only be carried out while the application is in the appropriate mode. However, keyframing can be carried out in either mode, and thus the user may move Edit time marker 619 to a position on the Edit timeline at which he knows he wants the keyframe, add a keyframe at the corresponding Action time, and then play the animation while in the Edit mode in order to view the Edited animation. Conversely, keyframing can be carried out entirely within the Action interface.

If the question asked at step 1201 is answered in the affirmative, to the effect that the Edit marker was moved, then at step 1202 the Action time corresponding to the new position of Edit marker 619 is obtained from forward time transformation table 701. If the question asked at step 1201 is answered in the negative, to the effect that the Action marker 618 was moved then the current Action time is obtained from the new position of the marker and at step 1203 the current Edit time is obtained from backward time transformation table 702.

Following either of steps 1202 or 1203, at step 1204 the Action marker 618 is displayed at the current Action time on Action timeline 601, and the Edit time marker 619 is displayed at the current Edit time on Edit timeline 602. Thus, whichever time marker is moved the corresponding time in the other interface is calculated and the other time marker is also moved.

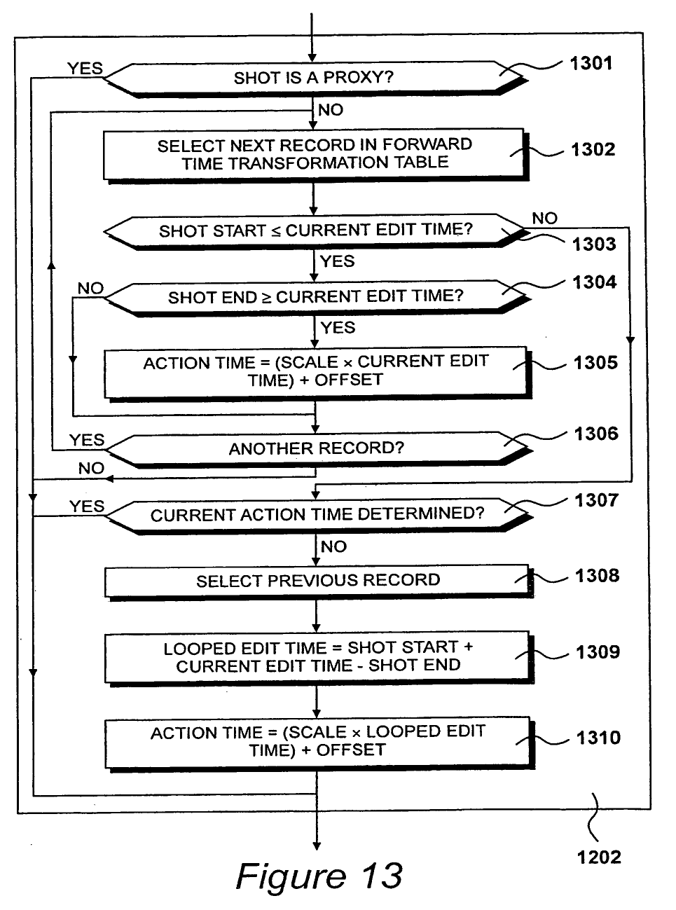

FIG. 13

FIG. 13 details step 1202 at which a current Action time is obtained by transforming a new current Edit time. It is possible to create a shot that does not link to any Action time but that is entirely associated with a video file. In this case, the video will not be played within the animation but will be played instead of animation. This can be used to insert video from other projects, thus allowing more than one scene to be created at once. Thus during the playing of a proxy shot there is no Action time, and so at step 1301 a question is asked as to whether the shot is a proxy, and if this question is answered in the affirmative then step 1202 is concluded.

If, however, it is answered in the negative then at step 1302 the first record in forward time transformation table 701 is selected. At step 1303 a question is asked as to whether the value in column 702, indicating the start of the shot to which this record applies, is less than the current Edit time. If this question is answered in the affirmative then a further question is asked at step 1303 as to whether the value in column 703, indicating the end of the clip is greater than the current Edit time. If this question is also answered in the affirmative then the current Edit time falls within the shot start and finish times of the record and thus the current Action time is obtained by multiplying the Edit time by the scale value for that record and adding it to the offset at a step 1305. Alternatively, if the question asked at step 1304 is answered in the negative then both the start and end times of the record are earlier than the current Edit time, and so in this case or following step 1305 a question is asked at step 1306 as to whether there is another record in the table. If this question is answered in the affirmative control is returned to step 1302 and the next record in the table is selected, while an answer in the negative concludes step 1202.

If at any time the question asked at step 1303 is answered in the negative, to the effect that the shot start time of the current record is greater than the current Edit time, then since the records in table 701 are arranged in numerical order there is no further record containing the current Edit time. Thus a question is asked at step 1307 as to whether a current Action time has been determined. If this is answered in the affirmative then step 1202 is completed. If, however, it is answered in the negative then this means that there is no shot at the position of Edit marker 619. When this occurs the previous shot is looped and so at step 1309 the previous record is selected. At step 1309 a looped Edit time is set to be the shot end time subtracted from the current Edit time, added to the shot start time. The Action time is then calculated at step 1310 to be the looped Edit time multiplied by the scale of the selected record, with the whole added to the offset.

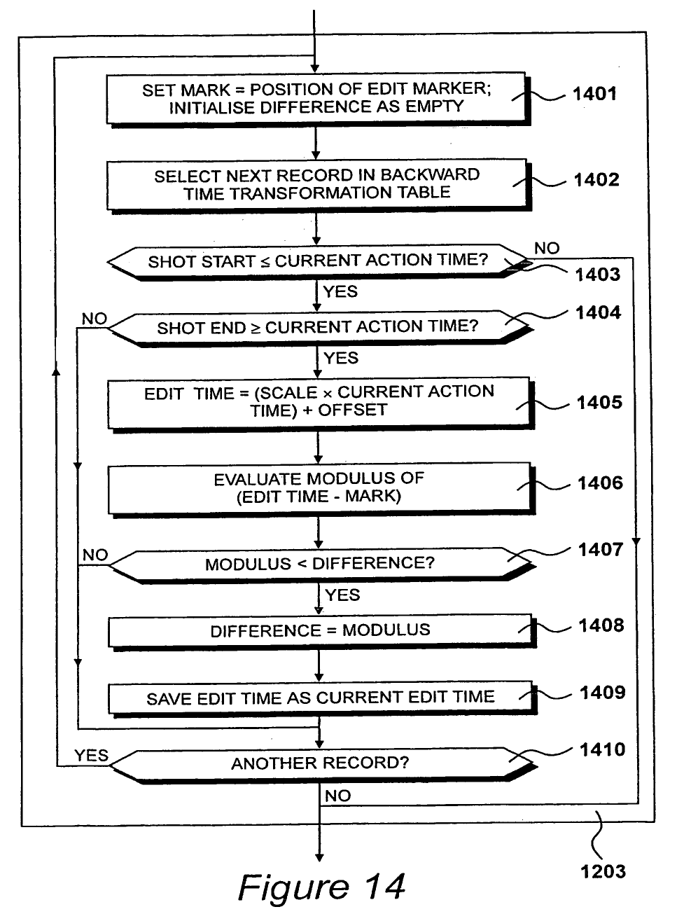

FIG. 14

FIG. 14 details step 1203 at which a new current Edit time is obtained from a new current Action time. This procedure is slightly different from its reverse described with respect to FIG. 13, because if the current Action time corresponds to more than one Edit time then the time that is closest to the previous position of the Edit marker is used. To this end the current position of Edit marker 619 on the Edit timeline is saved as a variable called MARK at step 1401 and a variable DIFFERENCE is initialised to be empty at step 1402.

At step 1402 the first record in backward time transformation table 702 is selected and at step 1403 a question is asked as to whether the shot start time of this record is less than or equal to the current Action time. If this question is answered in the negative then the selected record is after the current Action time. Since the records are organised in numerical order by the shot start value in table 702, this means either that the current Edit time has already been found or that there is no Edit time corresponding to the new Action time. In the latter case, in contrast to the procedure used during step 1202, it is acceptable for the Edit time to be empty and the time marker 619 will not be displayed on Edit timeline 602.

Alternatively, if the question asked at step 1403 is answered in the affirmative then at step 1404 a further question is asked as to whether the shot end value is greater or equal to the current Action time. If this question is answered in the negative then control is directed to step 1410 at which a question is asked as to whether there is another record in the table, and if this question is answered in the affirmative control is returned to step 1402 and the next record is selected. If, however, it is answered in the affirmative then at step 1405 an Edit time corresponding to the current Action time is calculated as the product of the current Action time and the scale value in the current record, added to the offset value.

At step 1406 the difference between this Edit time and the previous position of the Edit time marker is calculated by taking the modulus of the variable MARK subtracted from this Edit time. At step 1407 a question is asked as to whether this modulus is less than the value of the variable DIFFERENCE. On the first iteration this question will always be answered in the affirmative and at step 1408 the value of the variable DIFFERENCE is set to be this modulus. The calculated Edit time is then saved as the current Edit time at step 1409. Alternatively, if the modulus is not less than DIFFERENCE on a subsequent iteration, steps 1408 and 1409 are bypassed. The question is then asked as to whether there is another record at step 1410, with an answer in the affirmative returning control to step 1402 and an answer in the negative concluding step 1203. Thus, following the final pass of these steps, the current Edit time will be the Edit time corresponding to the current Action time that is closest to the position of the previous Edit marker.

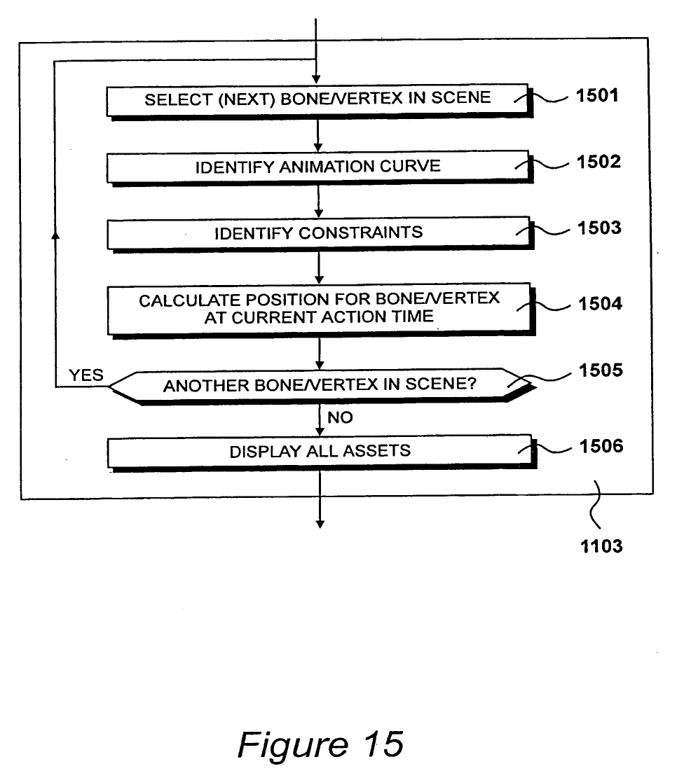

FIG. 15

FIG. 15 details step 1103 at which the 3D data is evaluated and displayed following the movement of a time marker. At this point, no matter which marker has been moved, the application has a current Action time, and it is this time that is used to perform the evaluation. At step 1501 the first bone or vertex in the scene is selected. At its most basic level, a scene is composed entirely of bones and vertices which make up larger assets, and so these are considered one at a time. At step 1502 any animation curves belonging to the selected bone or vertex are selected and at step 1503 any constraints on it are identified. At step 1504 a position for it is calculated with respect to the current Action time by considering the identified animation curve and constraints in combination with the bone or vertex's defined position.

At step 1505 a question is asked as to whether there is another bone or vertex in the scene and if this question is answered in the affirmative control is returned to step 1501, while if it is answered in the negative then at step 1506 all assets in the scene are displayed. This step involves considering the point of view of the camera in use and translating every 3D position within the 3D world to a two-dimensional position on a plane, with respect to lighting and whether or not an object is visible behind another object. This two-dimensional data (image data) is then displayed in viewer 902.

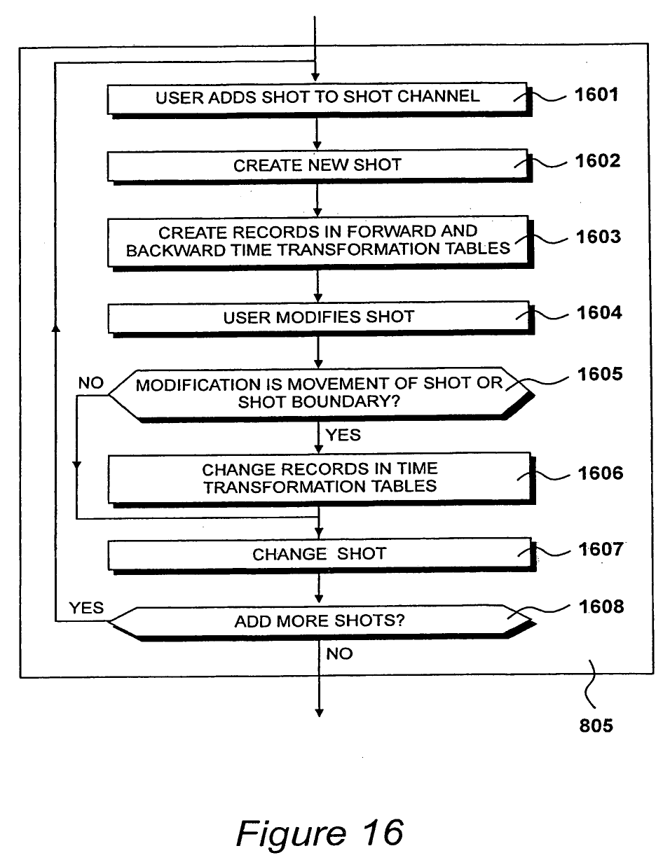

FIG. 16

Once animation data has been created at steps 801 to 804, the user can create shots in the Edit interface in order to control how the animation is played. Although changes to the animation may be made while the application is in Edit mode, changes made within the Edit interface cannot affect the actual animation. For example, they cannot change the appearance of a character, change his animation curve or change the way he interacts with other objects. Shots created within the Edit interface only affect how the animation is viewed; for example, by jumping forwards and backwards on the Action timeline the Edited animation can change the order of events, possibly repeating some events and leaving others out entirely. Time can be contracted or dilated. Additionally, shots in the Edit interface can be overlapped to create a blend, wipe, or other type of editing effect. This gives rise to the plurality of current Action times as described with reference to FIG. 7.

Thus at step 805 detailed in FIG. 16, the user creates shots in Edit interface 905. At step 1601 the user adds a shot to shot channel 616 and at step 1602 a new shot is created. In this embodiment, a shot is a record in a table, containing the start and end times, the camera to be used and any link to a video file. At step 1603 records are created in the tables constituting time reference data 507, and at step 1604 the user modifies the shot if required. As an alternative, an Edit Decision List (EDL) could be loaded and used to create shots.

Modifications may include changes to the start and end time, the camera to be used or the video associated with it. If the shot is a proxy of animation data from another project then the user may, for example by “double-clicking” on the relevant shot within Edit interface 905, save and close the current project and load the project data that the shot refers to.

At step 1605 a question is asked as to whether this modification comprises movement of the shot in time, or movement of one of its boundaries. If this question is answered in the affirmative then the records in the time transformation tables 701 and 702 are altered at step 1606, following which, or if the question is answered in the negative, the shot itself is altered at step 1607.

At step 1608 a question is asked as to whether the user wishes to add more shots and if this question is answered in the affirmative control is returned to step 1601, while if it is answered in the negative step 805 is concluded.

The skilled reader will appreciate that this description of shot modification is only an example. Modifications to shots could be carried out using an interface such as described here, using a menu system, allowing the user to type in values, or any other interface that allows the user to specify that particular times in the Edit timeline are associated with times in the Action timeline.

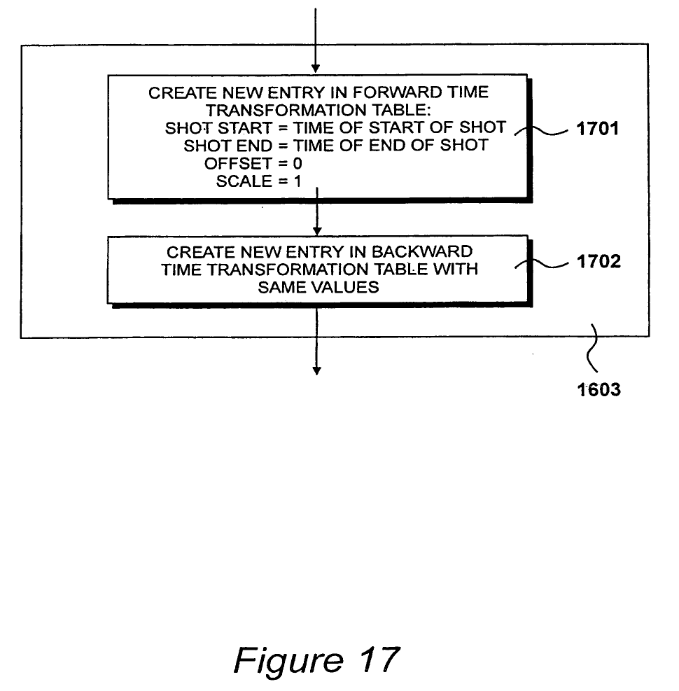

FIG. 17

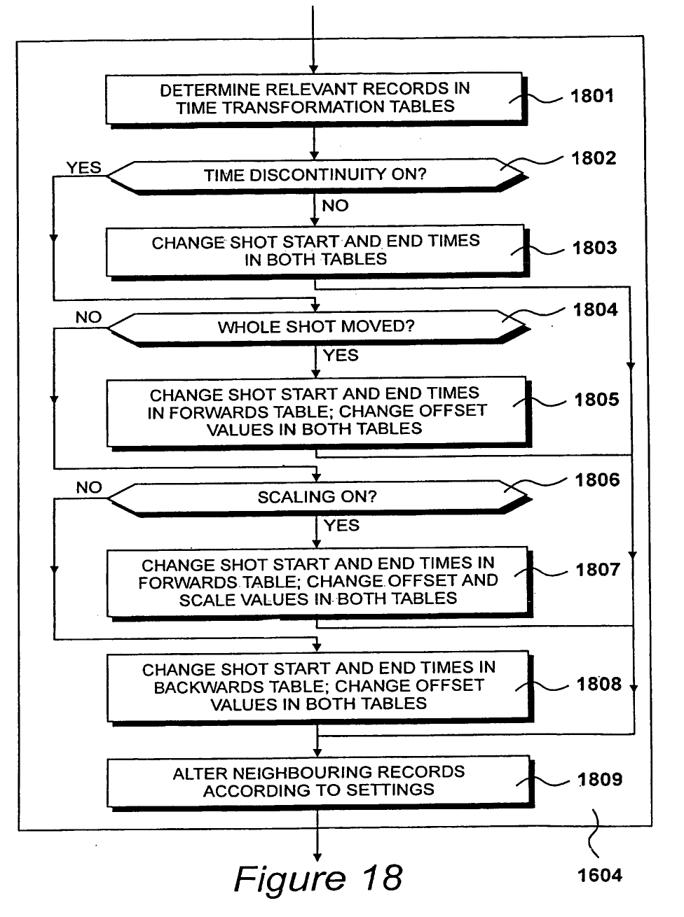

FIG. 17 details step 1603 at which records in the time transformation tables 701 and 702 are modified. At step 1701 a new entry is created in forward time transformation table 701, with the value in column 703 being the time of the beginning of the shot, the value in column 704 being the time of the end of the shot, the value of offset column 705 being 0 and the value of scale column 706 being 1. At step 1702 a new entry in backward time transformation table 702 having the same values has created. Thus when a shot is first created it relates to exactly the same time in the Action timeline. However, modifications performed by the user at step 1604 can change this, as described with respect to FIG. 18.

FIG. 18

FIG. 18 details step 1604 at which the records in the time transformation tables are modified following the movement of a shot or the boundary of a shot by the user at step 1604. At step 1801 the records relevant to this shot in the time transformation tables are determined. At step 1802 a question is asked as to whether time discontinuity is on. This is a mode which can be switched on via the menu 910 when the application is in Edit mode. It allows the user to create shots in the Edit timeline that relate to different-times in Action. Thus if this question is answered in the negative the shot start and end times are changed identically in both tables, since when time discontinuity is off the relationship between the Edit and Action timelines is not altered. Thus, for example, if a shot is created between 0 and 2 seconds in Edit it will relate to the animation between 0 and 2 seconds in Action. If this shot is then moved while time discontinuity is off so that it runs from 2 to 4 seconds in Edit, it will show the animation that occurs between 2 and 4 seconds in Action. If time discontinuity is on, it will still relate to the animation between 0 and 2 seconds in the Action timeline, but will play from 2 to 4 seconds in Edit.

Thus, if the question asked at step 1802 is answered in the affirmative, to the effect that time discontinuity is on, then at step 1804 a further question is asked as to whether the whole clip was moved. If this question is answered in the affirmative then the following changes are made to the time transformation tables: the shot start and end times are changed only in the forwards table 701, while the offset values are changed in both.

If the question asked at step 1804 is answered in the negative, to the effect that the whole clip was not moved, then one boundary only was moved. A further question is thus asked at step 1806 as to whether scaling is turned on. Again, this is a function which can be accessed via menu 910. If scaling is on then shortening or stretching a shot in Edit results in a speeding up or slowing down of the playback respectively, while if scaling is off a change in length of the shot results in a decrease or increase of the amount of animation being seen. Thus if this question is answered in the affirmative, to the effect that scaling is on, the following changes are made in the transformation tables at step 1807: the shot start and end times are changed in the forward table 701 only and the offset and scale values are changed in both tables. If however, scaling is off and the question asked at step 1806 is answered in the negative, then at step 1808 the shot start and end times are changes in the backwards table 702 only and the offset values are changed in both.

Step 1809 follows any of steps 1803, 1805, 1807 and 1808, where records immediately before or after the affected records in the time transformation tables may be altered, according to user controlled settings. These settings control what happens to a shot when the user moves its neighbour, for example preventing gaps, preventing overlaps, creating blends and so on.

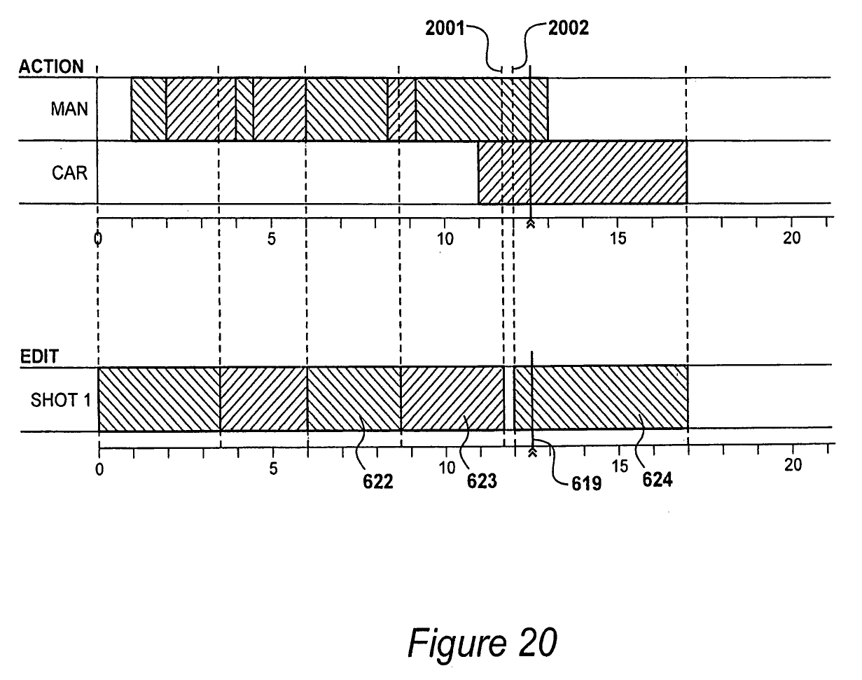

The effects of the changes made in step 1604 will be illustrated in FIGS. 20 to 23.

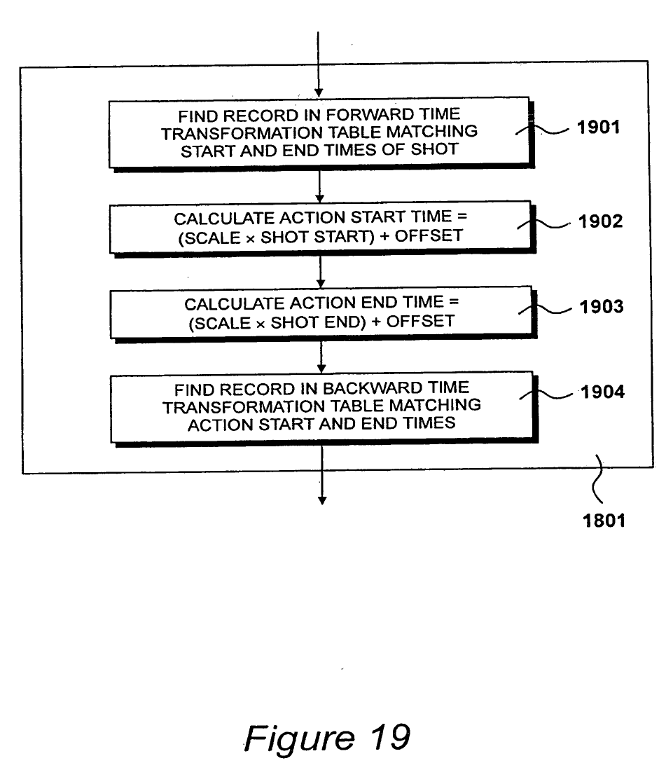

FIG. 19

FIG. 19 details step 1801 at which the relevant records in the time transformation tables are selected in order to alter them, when the user modifies a shot. At step 1901 the record in the forward time transformation table that has shot start and end values matching the beginning and end times of the shot under consideration is found. At step 1902 the product of the shot start value of this record and the scale value is added to the offset to obtain an Action start time, and at 1903 the same is performed for the shot end value to obtain an Action end time. At step 1904 the record in backward time transformation table 702 having shot start and end times matching the times calculated at steps 1902 and 1903 is found. Thus the records corresponding to the shot being modified have been found in both tables.

FIG. 20

FIG. 20 shows the Action and Edit timelines shown in FIG. 6 at an earlier stage in the modification of the project data. At this stage, the man and the car have both been animated but no audio has been added. Shots have been created on the Edit timeline but any modifications to these shots were done while time discontinuity was off. Thus, at this point, the relationship between the Action and Edit timelines is that they are identical, as shown by the dashed lines indicating the beginning and end of the shots and by time markers 618 and 619. Playback in Action or Edit would at this stage be very similar; however, the Edit timeline serves the function of a camera switcher, since when playing in Edit mode the camera associated with each shot is used in preference to any camera specified in the Action interface.

It can also be seen that the there is a gap between shots 623 and 624, which would lead to a looping of the beginning of shot 623 at this point if the animation were played in Edit mode, whereas if the animation were played in Action mode then the animation between dotted lines 2001 and 2002, which would be missed out in Edit mode, would be played.

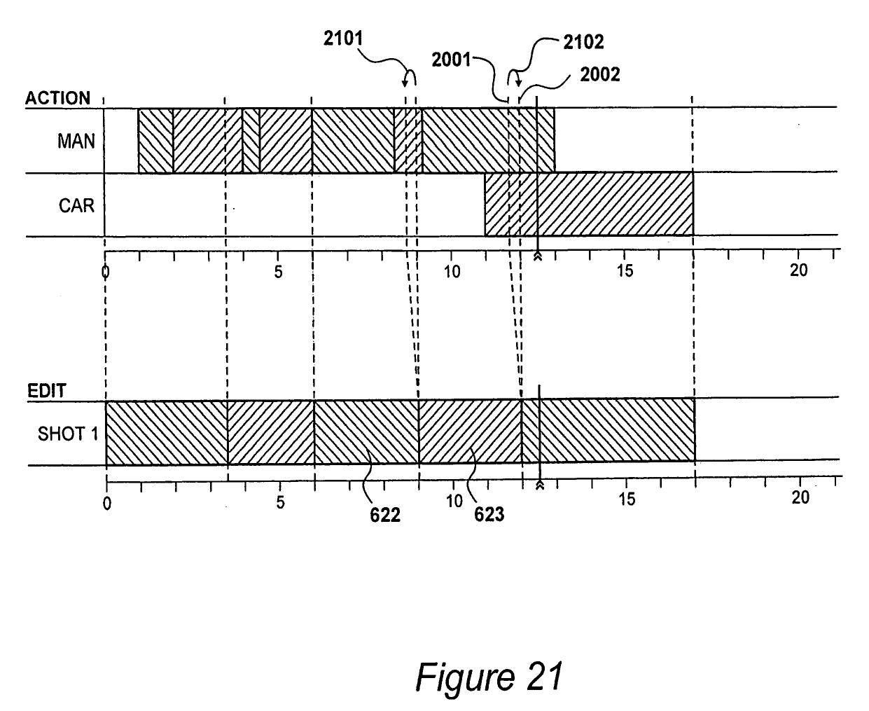

FIG. 21

FIG. 21 shows FIG. 20 after shot 623 has been moved to the right to close up the gap while: time discontinuity is switched on. Because time discontinuity is on, the shot refers to the same times in Action as it did before, but it has been moved in the Edit timeline. The user has then switched time discontinuity off and moved the leading edge of shot 622 to close the gap. Thus, at 9 seconds in Edit the animation being played jumps backwards to 8.7 seconds in Action, as shown by arrow 2101. At the end of shot 623 the animation between dotted lines 2001 and 2002 is still missed out, as shown by arrow 2102.

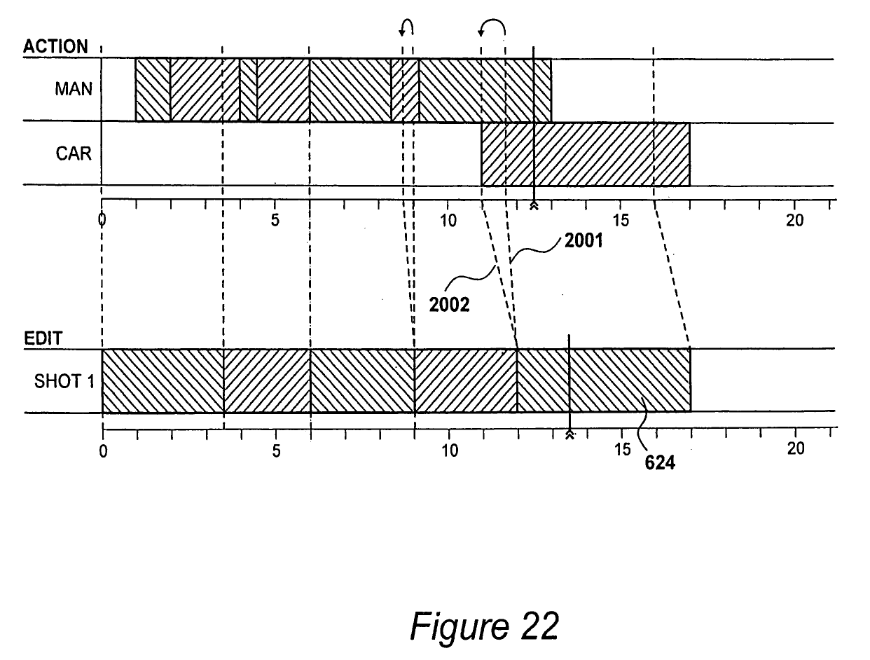

FIG. 22

FIG. 22 shows FIG. 21 after shot 624 has been moved. In this example, the user has turned time discontinuity on and scaling off and then moved the leading edge of shot 624 forwards in time (to the left) by 1 second. Because scaling is off, the clip in Edit that runs from time 12 to 17 now refers to time 11 to 16 in Action. Dashed lines 2002 and 2001 have therefore reversed position. Where previously the animation between lines 2001 and 2002 was not played, now the animation between 2002 and 2001 is repeated.

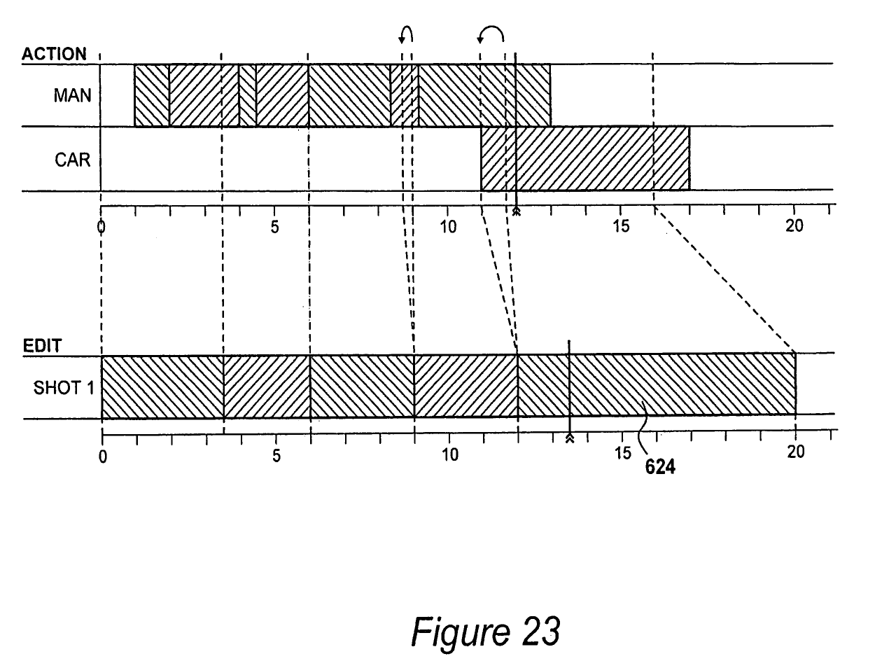

FIG. 23

Finally, the user turns both time discontinuity and scaling on and moves the trailing edge of shot 624. This causes playback of the animation to be slowed down during this shot, with the animation taking place between 11 and 16 seconds in Action being played between 12 and 20 seconds in Edit.

The addition of the audio now completes the example shown in FIG. 6.

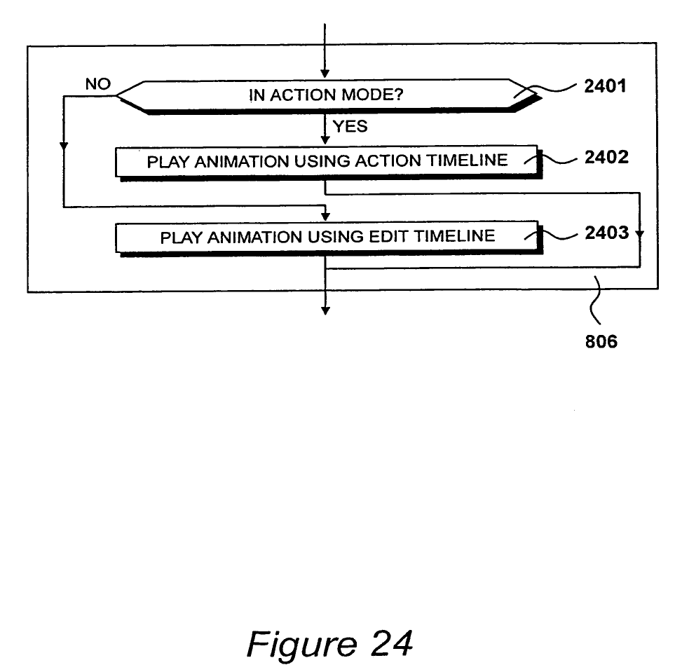

FIG. 24

FIG. 24 details step 806 at which the animation created at steps 801 to 805 is played. This is triggered by the user selecting the play button in transport controls 907. At step 2401 a question is asked as to whether the application is in Action mode. If this question is answered in the affirmative then the animation is played using the Action timeline at step 2402 while if it is answered in the negative the animation is played using the Edit timeline at step 2403.

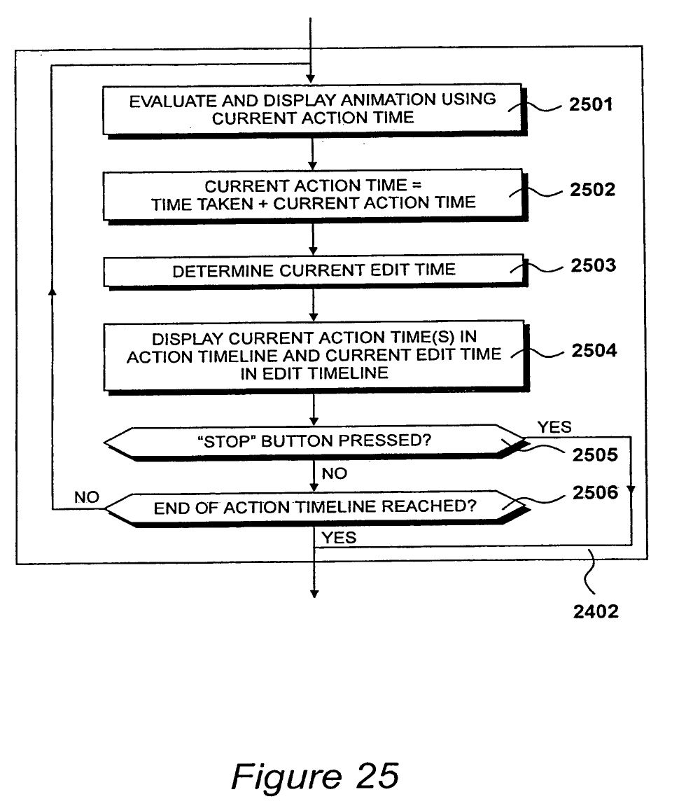

FIG. 25

If the animation is played using the Action timeline then the resulting image data is that which would be produced were the Edit interface and timeline not to exist. However, during playback the Edit time marker 619 is moved to indicate the correspondence between the two timelines. This is shown in FIG. 25, which details step 2402.

At step 2501 the 3D data is evaluated using the current Action time and the image data thus produced is displayed in viewer 902. This evaluation step is substantially identical to step 1103 described in FIG. 15, and thus will not be elaborated on further. At step 2502 a new Action time is calculated by adding the time taken to perform step 2501 to the previous current Action time, and at step 2503 a new current Edit time corresponding to this new current Action time is determined, in the same way as at step 1202 detailed in FIG. 13.

At step 2504 the current Action time is displayed by placing time marker 618 at the appropriate time on Action timeline 601, while the Edit time is similarly displayed using Edit time marker 619 on Edit timeline 602. At step 2504 a question is asked as to whether the stop button in the transport controls 907 has been pressed and if this question is answered in the negative then a further question is asked as to whether the end of the Action timeline has been reached. If either of these questions is answered in the affirmative then playback is ceased, while if the question asked at step 2506 is answered in the negative then control is returned to step 2501 and the next evaluation of the 3D data is made.

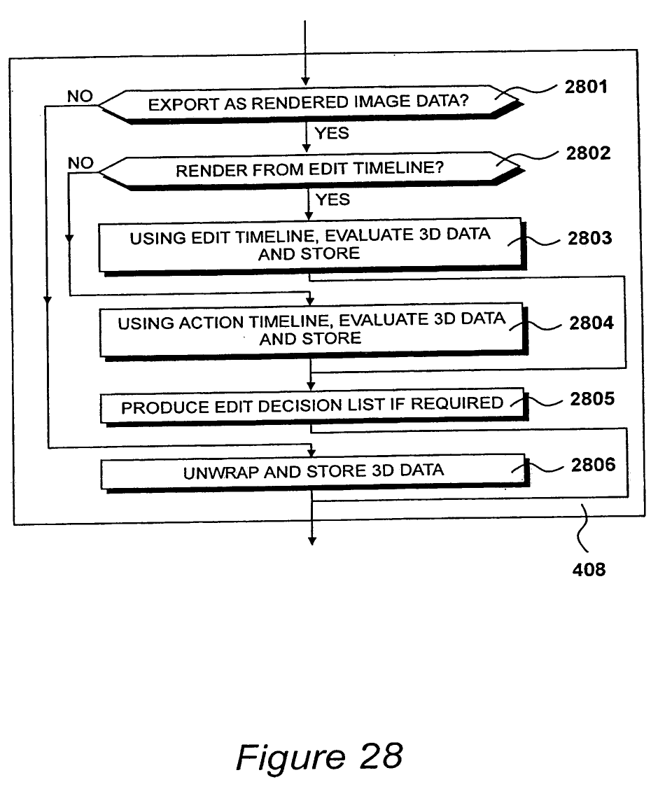

By updating the current Action time as described with reference to FIG. 25, the animation displayed in viewer 902 proceeds at the correct speed. Even though a lack of memory or a slow processor could cause the animation to appear jerky because the interval between renderings is large, if the animation were to be evaluated once per frame then depending upon the resolution used the animation would run either too slow or too fast, which would be confusing for the user. Conversely, as will be described with reference to FIG. 28, when the animation is finished it is exported and during this process a set number of frames are produced, according to user-defined settings. In that case, since the animation is being exported rather than displayed, the speed at which the frames are produced is irrelevant.

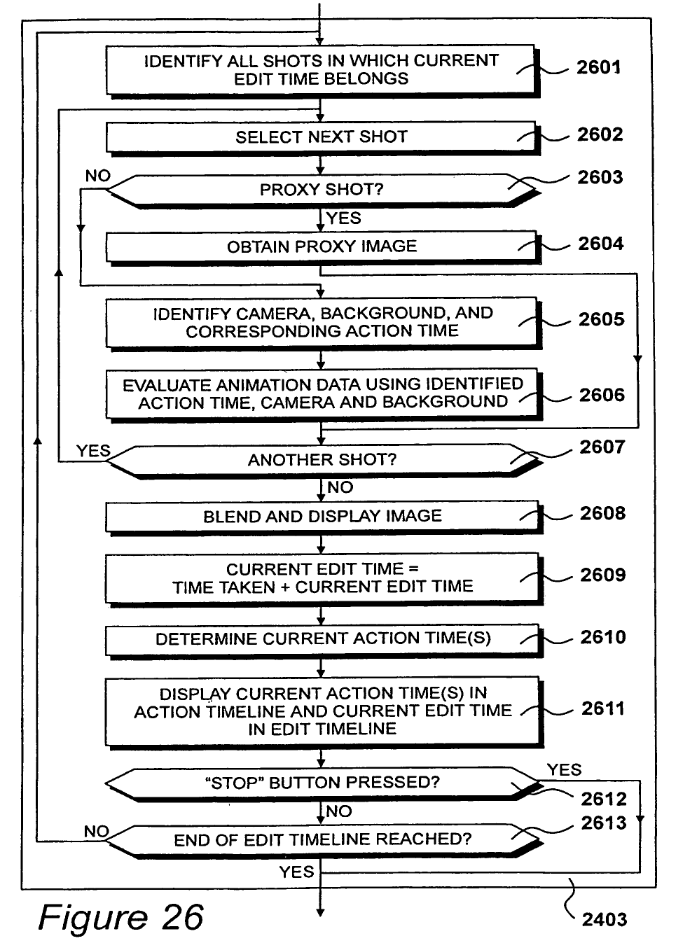

FIG. 26

FIG. 26 details step 2403, at which playback in Edit mode is performed. At step 2601 all the shots to which the current Edit time belongs are identified. As previously described, shots can overlap in order to produce fades, blends and so on, and so it is possible for an Edit time to belong in more than one shot.

At step 2602 the first of these shots is selected and at step 2603 a question is asked as to whether the shot is a proxy shot. If this question is answered in the affirmative then at step 2604 the frame of the proxy at the current Edit time is obtained, following which control is directed to step 2607.

If the question is answered in the negative then at step 2605 the camera and background associated with that shot are identified, and also the value of the current Action time that is associated with the shot. At step 2606 this Action time is used to evaluate the animation data, with the camera and background identified at step 2605 overriding any camera and background selection contained in the Action interface. This is carried out in much the same way as step 1103 detailed in FIG. 15, except that the final display following the production of the image data is not carried out.

At step 2607 a question is asked as to whether another shot was identified at step 2601, and if this question is answered in the affirmative then control is returned to step 2602 and the next shot is selected. If it is answered in the negative then at step 2608 the images obtained at steps 2604 and 2606 are blended and displayed. If there was only one shot identified at step 2601 then the image data is displayed without blending.

At step 2609 the current Edit time is incremented by the amount of time it took to perform steps 2601 to 2608, and at 2610 new current Action times are determined. At step 2611 the current Edit and Action times are displayed in their respective timelines and at step 2612 a question is asked as to whether the stop button has been pressed. If this question is answered in the negative then a further question is asked at step 2613 as to whether the end of the Edit timeline has been reached, and if this question is answered in the negative control is returned to step 2601 to produce the next image. If either of these questions is answered in the affirmative then playback ceases.

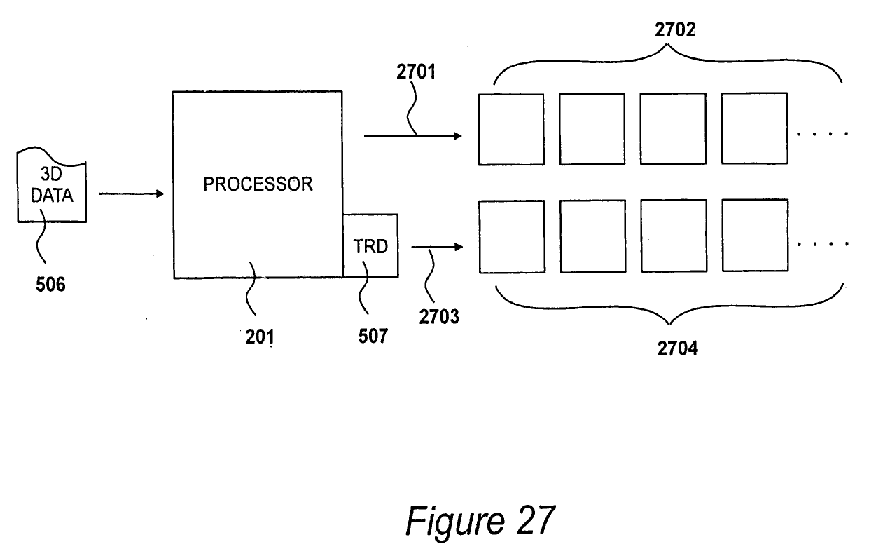

FIG. 27

FIG. 27 illustrates the process of playing the animation, as detailed in FIG. 24, in a block diagram. 3D data 506 is used by processing system 201 to output image data. When the image data is played using the Action timeline, the 3D data is processed with respect to normal time, as shown by arrow 2701, to produce frames of image data 2702. However, when the Edit timeline is used the time reference data 507 is used to process time before the 3D data is processed as shown by arrow 2703, to produce frames of image data 2704. Thus processing means 301 is configured to evaluate 3D data 506 stored in memory means 305 with respect to a first function of time in a first evaluation mode and with respect to a second function of time in a second evaluation mode. In this example, the first function of time allows a time reference to pass through it unchanged, while the second function of time transforms a time reference with respect to time reference data 507.

FIG. 28

FIG. 28 details step 408 at which data is exported if required. At this stage it is possible to export image data, similar to that obtained by playing the animation at step 806, or animation data, which is in a similar form to 3D data 506. For example, a user would render the 3D data to produce image data if the aim of the project were to produce frames of image data to be used in a film. The export of 3D data would be used, for example, when the project is for a computer game suitable for playing on a home computer system, games console and so on. These games frequently contain sections of animation known as cut scenes, during which gameplay stops and the user views a short scene of image data which generally elaborates on some aspect of the storyline or explains the rules. In order to conserve storage space on the medium on which this game is stored, usually a CR-ROM, it is typical to store these cut scenes as animation data rather than image data. The graphics card in the computer or console then uses the animation data to produce the required image data in the same way that it produces the image data representing gameplay. This is substantially the same as the rendering process at step 1103.

These examples show that the ability to export both image data and animation data is important. Thus at step 2801 a question is asked as to whether the animation is to be exported as rendered image data. If this question is answered in the affirmative then at step 2802 a further question is asked as to whether this rendering should be performed using the Edit timeline. If this question is answered in the affirmative then at step 2803 the 3D data is evaluated using the Edit timeline and stored. This evaluation is substantially similar to that that takes place at step 2403. The main differences in this embodiment are that, as previously described, the rendering produces a number of equally spaced frames, the interval between frames being dependent upon the number of frames per second that are required, and also that the image data is not output to display means 202 but is stored on hard disk drive 306. From here it may be written onto a CD-ROM or sent via network means 207 to a third party. Alternatively, the data may be rendered directly to some other external storage means.

If the question asked at step 2802 is answered in the negative, to the effect that the render is to take place from the Action timeline, then this is carried out at step 2804. Again, this is in substantially the same manner as at step 2402 except that a specified number of equally spaced frames are produced and the data is stored rather than displayed.

Following either of steps 2803 or 2804, an Edit Decision List may be produced from the shots in Edit timeline 602. This is particularly relevant if the data was rendered using the animation timeline, in which case the EDL indicates the editing which the animator has decided upon, but does not limit a later editor to using this editing, as is the case if the animation is output using Edit timeline 602.

If the question asked at step 2801 is answered in the negative, to the effect that the animation data is to be exported as 3D data, and not as rendered image data, then at step 2806 the existing 3D data 506 undergoes a process known as “unwrapping” in which the 3D data is altered such that the playback is identical whether it is played in Edit or Action mode. This means that the editing performed by the user becomes permanent. The 3D data may also be simplified. When this process is complete the animation data is stored in hard disk drive 306 ready for export in any appropriate manner. The exported 3D data thus produced can be rendered by any computer system or games console fitted with a graphics card capable of rendering animation data.

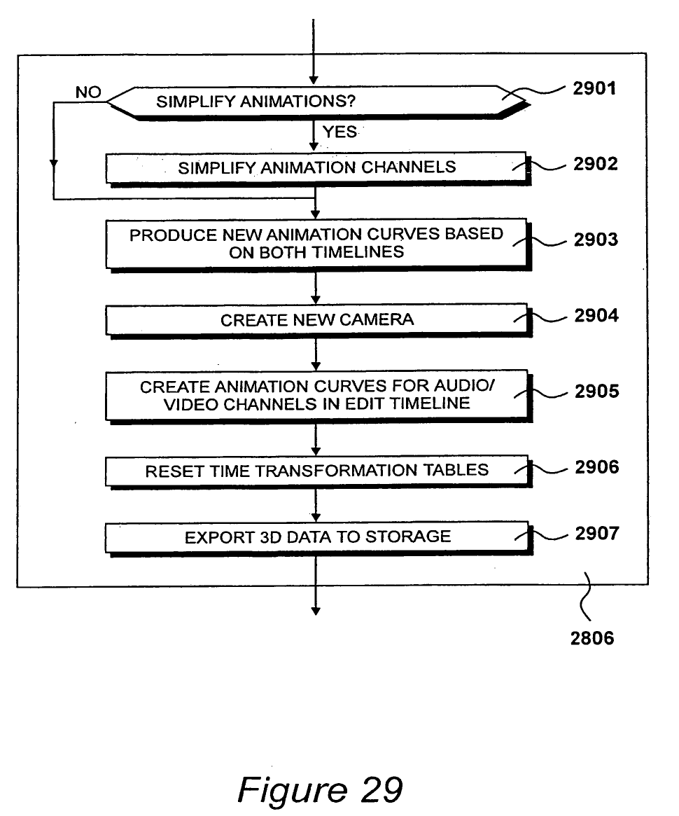

FIG. 29

FIG. 29 details step 2806 at which the 3D data is unwrapped and stored. At step 2901 a first question is asked as to whether the animation should be simplified as part of the unwrapping process. If this question is answered in the affirmative then the simplification process is carried out at step 2902. This process may reduce the amount of information in each animation channel, depending upon what is contained within the 3D data. It may be bypassed if not required, and could also be used at any time during the modification of the 3D data and not just as part of the unwrapping process.

Following step 2902, or if the question asked at step 2901 is answered in the negative, at step 2903 new animation curves are produced and at step 2904 a new camera channel is created, while at step 2905 animation channels for any audio or video data in the Edit timeline are created in the Action timeline. At step 2906 the time transformation tables are reset by changing all the offset values to 0 and all the scale values to 1 in the forward transformation table 701, and making the backward transformation table 702 identical to the forward table. At step 2907 the 3D data produced by steps 2901 to 2906 is exported to storage.

Thus, at the end of step 2806, 3D data, has been produced that produces substantially identical image data whether played in the Edit timeline or Action timeline. This means that once an animator has edited 3D data to his satisfaction using the Edit timeline, he can produce animation data that will have the same effect when rendered using a standard graphics card, or indeed any animation application, without the need for the Edit timeline.

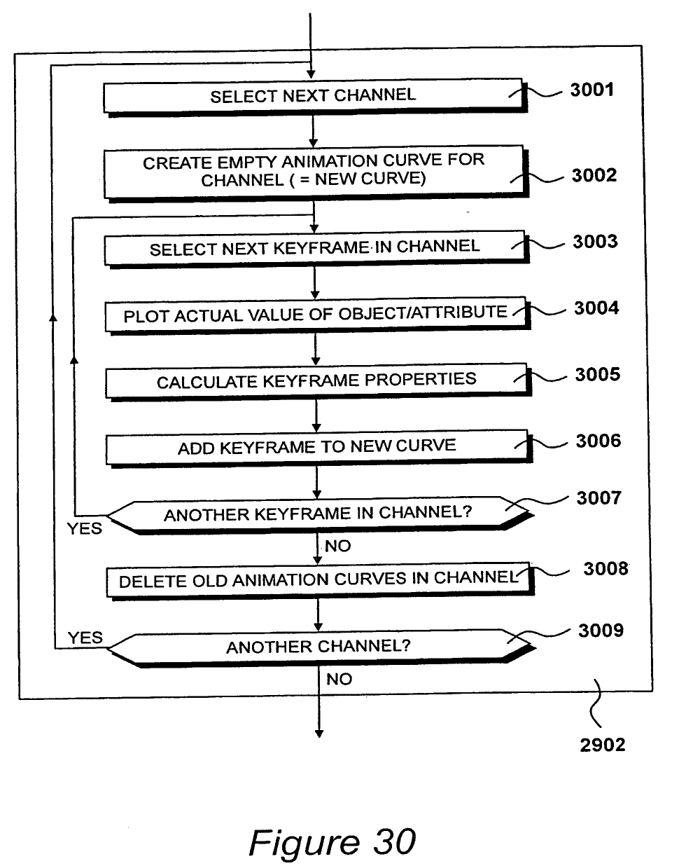

FIG. 30

FIG. 30 details step 2902 at which the animation channels are simplified. At step 3001 the first channel in the animation data is selected and at step 3002 an empty animation curve is created for this channel, which will be referred to in the description of this Figure as the new curve. At step 3003 the first keyframe in the channel is selected and at step 3004 the actual value of the object or attribute to which the channel refers at the time indicated by this keyframe is plotted. Thus, for example, the object may be constrained such that its actual position is not that indicated by the animation curve at that time. Alternatively, two animation curves may have been blended together such that the actual value is not that indicated by either animation curve but is an interpolation between them. Alternatively again, the value of the object may be exactly that given by the animation curve. Thus, at step 3005 the properties of a keyframe that would give this plotted value at the specified time are calculated and at step 3006 a keyframe having these properties is added to the new curve.

At step 3007 a question is asked as to whether there is another keyframe in the channel and if this question is answered in the affirmative control is returned to step 3003 and the next keyframe is selected. Alternatively, if the question is answered in the negative then all keyframes in the channel have been considered and thus all the old animation curves in the channel are deleted at step 3008. At step 3009 a further question is asked as to whether there is another channel to be considered, and if this question is answered in the affirmative control is returned to step 3001 and the nest channel is selected. Alternatively, step 2902 is concluded.

Thus, following the simplification of the animation channels, each animation channel contains a single curve which takes account of any constraints, blending of curves, or any other type of special feature which an animation application could apply, which were applied to the previous animation curves in the channel. This reduces the amount of storage space required by the 3D data, and also ensures that the 3D data can be rendered to produce image data using even a basic graphics card.

As previously discussed, this simplification process could be used on its own, and need not be part of the unwrapping process. However, once it is performed it is more difficult to modify the animation and so it is usually carried out at the end of a project. For example, if the animator were handing over a finished scene in a film to another animator in order for him to integrate it with his scene, then he might simplify the animation first. Equally, if the 3D data is to be exported to an application that understands constraints, animation blends and other aspects of the 3D data but does not use an Edit timeline then the animation could be unwrapped without being simplified.

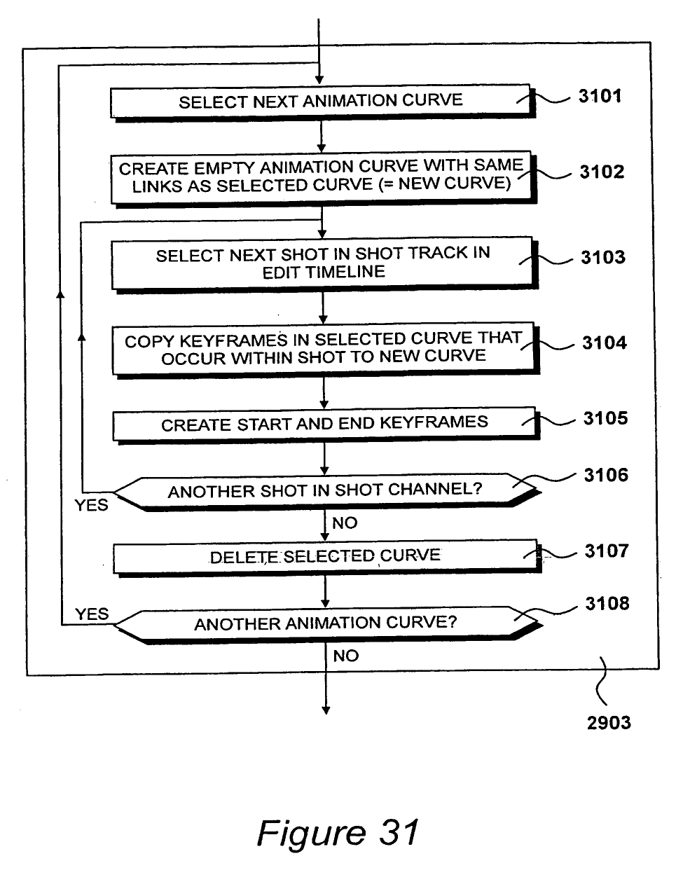

FIG. 31

FIG. 31 details step 2903, at which new animation curves are produced as part of the unwrapping process. At step 3101 the first animation curve in the 3D data is selected and at step 3102 an empty animation curve having the same links as the selected curve is created; it is referred to in the description of this Figure as the new curve. At step 3103 the first shot in the shot channel 616 in the Edit timeline 602 is selected, and at step 3104 the keyframes in the selected animation curve that occur during the selected shot are copied to the new curve. Thus, for example, a shot that goes from 1 to 3 seconds that has no scaling but an offset of −1 will contain keyframes that occur in the Action timeline from 0 to 2 seconds. Thus, at this step, any keyframes on the selected curve occurring between 0 and 2 seconds would be copied. At step 3105 start and finish keys for the shot are created. In the example just given this would create keyframes at 1 and 3 seconds if there had been no keyframes occurring at 0 and 2 seconds in the Action timeline.

At step 3106 a question is asked as to whether there is another shot in the shot channel and if this question is answered in the affirmative control is returned to step 3103 and the next shot is selected. If this question is answered in the negative then at 3107 the curve selected at step 3101 is deleted, leaving only the new curve that was created at step 3102 and populated during repeated iterations of steps 3103 and 3105.

A further question is then asked at step 3108 as to whether there is another animation curve in the 3D data. If this question is answered in the affirmative then control is returned to step 3101 and the next animation curve is altered. If it is answered in the negative then all the curves have been considered and step 2903 is concluded.

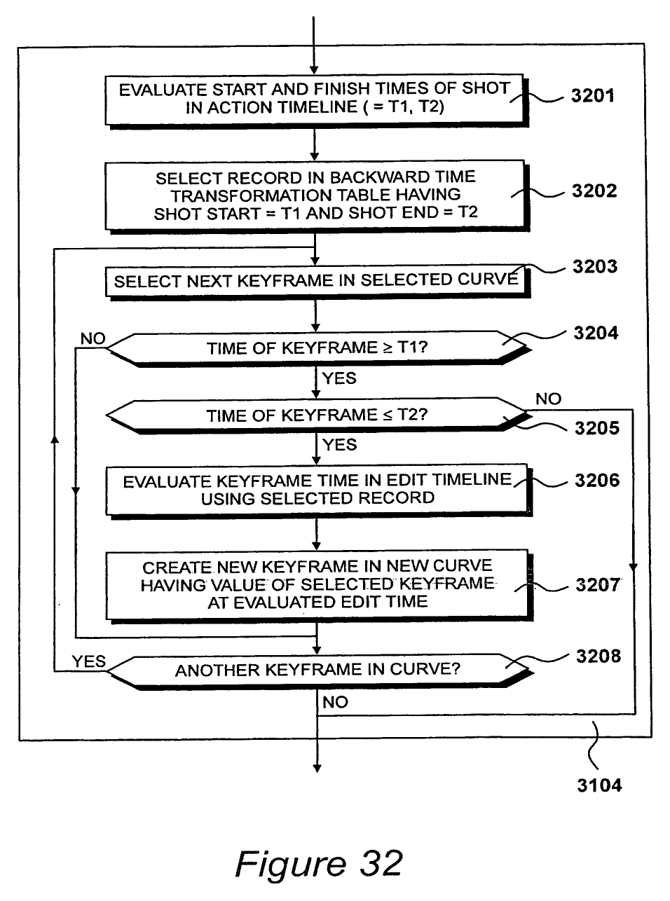

FIG. 32

FIG. 32 details step 3104 at which keyframes occurring on an animation curve within the selected shot are copied to the new curve. At step 3201 the shot start and end times, which are on the Edit timeline 602, are transformed using forward time transformation table 701 into times on the Action timeline 601. These times are referred to as T1 and T2 respectively. At step 3202 the record in backward time transformation table 702 that has time T1 as its shot start value and time T2 as its shot end value is selected. Only this record will be used for the following calculations, because it is the record that corresponds to the selected shot. If any other records were used for calculation then, since a time in Action may refer to many times in Edit, the wrong Edit time could be produced for a keyframe.

At step 3203 the first keyframe in the animation curve selected at step 3101 is selected and at step 3204 a question is asked as to whether the time of this keyframe is greater than or equal to time T1. If this question is answered in the negative then the selected keyframe occurs before the time of the selected shot control is directed to step 3208 to ask whether there is another keyframe in the curve. If it is answered in the affirmative then a further question is asked at step 3205 as to whether the time is less than or equal to time T2. If this question is answered in the negative then the keyframe occurs after the time of the selected shot; since the keyframes are considered in order this means that all further keyframes will also occur outside the shot and so step 3104 is concluded.

If the question is answered in the affirmative, however, then the keyframe occurs within the shot and so at step 3206 the time of the keyframe in the Edit timeline is evaluated using the scale and offset values of the record selected at step 3202. This gives the time at which the keyframe occurs if the animation is being played in the Edit timeline. At step 3207 a new keyframe is created in the new curve that has the same properties as the keyframe selected at step 3203 but is at the time evaluated at step 3206. (The skilled reader will here appreciate that the actual properties of a keyframe may change if it is moved in time; this is dependent upon the type of keyframe. The new keyframe is one that, when moved to the evaluated time, gives the same value for the animation as the keyframe selected.)

At step 3208 a question is asked as to whether there is another keyframe in the curve, and if this question is answered in the affirmative control is returned to step 3203 and the next keyframe is selected. If it is answered in the negative then step 3104 is concluded. This is also the case if the question asked at step 3205 is answered in the negative (since keyframes are considered in sequence).

At the end of step 3104 all the keyframes occurring within the selected shot have been copied to the new curve such that they occur in the Action timeline at the same time at which they would occur if played in the Edit timeline.

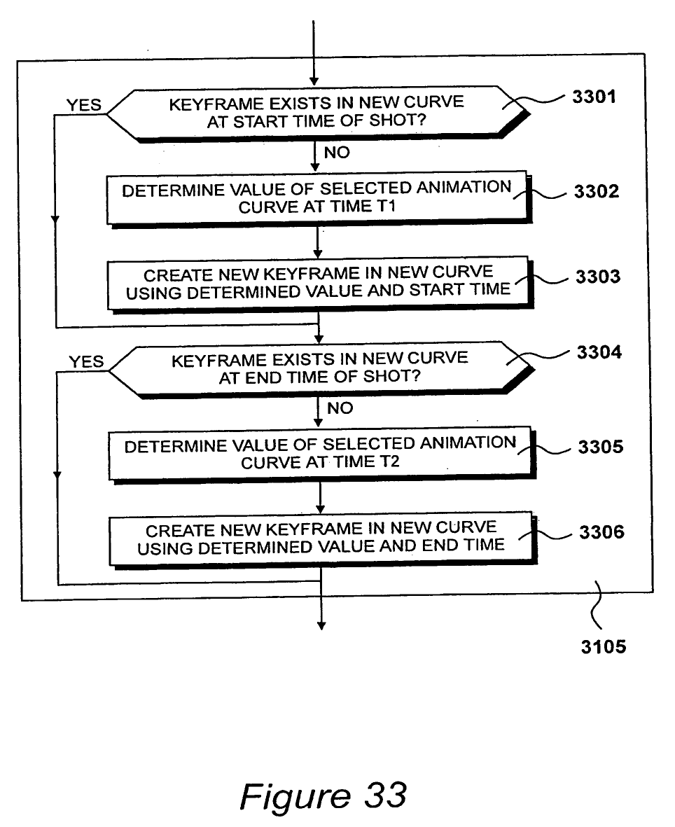

FIG. 33

FIG. 33 details step 3105 at which start and finish keys are created for the shot. At step 3301 a question is asked as to whether a keyframe exists in the new curve at the start time of the shot under consideration. If this question is answered in the affirmative then there is no need to add a start key and so steps 3302 and 3303 are bypassed. If, however, it is answered in the negative then at step 3302 the actual value of the animation curve at time T1, which is the time in animation corresponding to the start of the shot in Edit, is determined using the usual technique for interpolating between keyframes. At step 3303 the properties for a new keyframe having this value are determined and the keyframe is created in the new curve at the start time of the shot.

Similarly, at step 3304 a question is asked as to whether a keyframe already exists in the new curve at the end time of the shot, with an answer in the affirmative leading to the completion of step 3105. Alternatively, an answer in the negative means that the value of the selected animation curve at time T2 is determined at step 3305 and a keyframe given this value is created in the new curve at the end time of the shot at step 3306.

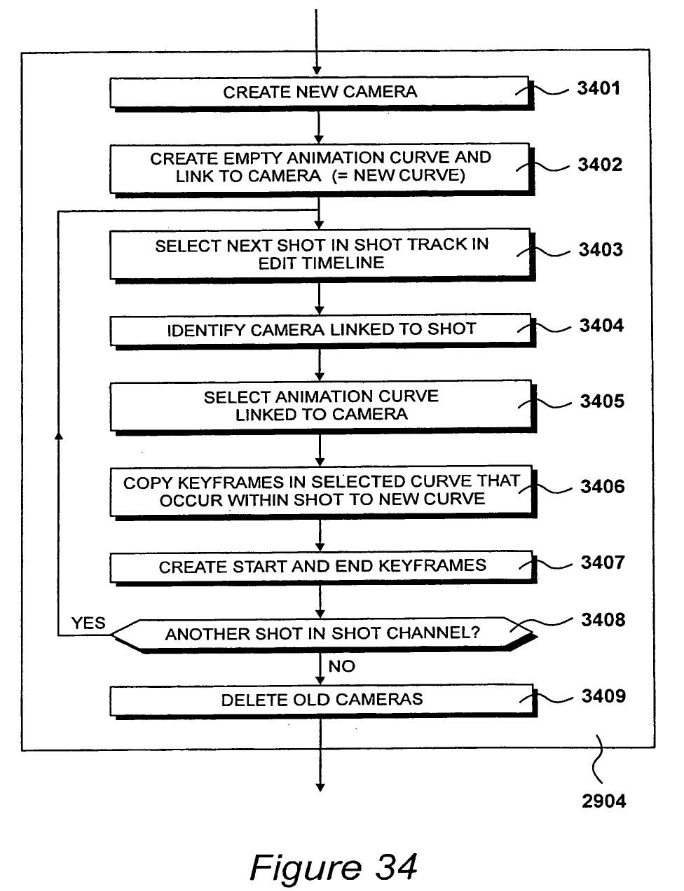

FIG. 34

FIG. 34 details step 2904 at which a new camera is created for the unwrapped animation. At step 3401 a new camera object is created in 3D data 506 and at step 3402 a new animation curve is created and linked to the camera object. This will be referred to as the new curve in the description of this Figure. At step 3403 the first shot in shot channel 616 in Edit timeline 602 is selected and at step 3404 the camera object linked to that shot clip is identified. At step 3405 the animation curve linked to this identified camera object is selected and at step 3406 the keys in this curve that occur within the timeframe of the selected shot are copied to the new curve, while at step 3407 start and finish keys are created. Steps 3406 and 3407 are substantially identical to steps 3104 and 3105 detailed in FIGS. 32 and 33; since camera objects can be animated in a similar fashion to any other objects the procedure is the same.

At step 3408 a question is asked as to whether there is another shot in shot channel 616 and if this question is answered in the affirmative control is returned to step 3403 and the next shot is selected. If it is answered in the negative then at step 3409 all camera objects except this new one are deleted.

Thus at the end of step 2904 a single camera has been created that is animated in order to jump between the positions of the camera objects it replaced, according to which cameras were associated with each of the shots in shot channel 616.

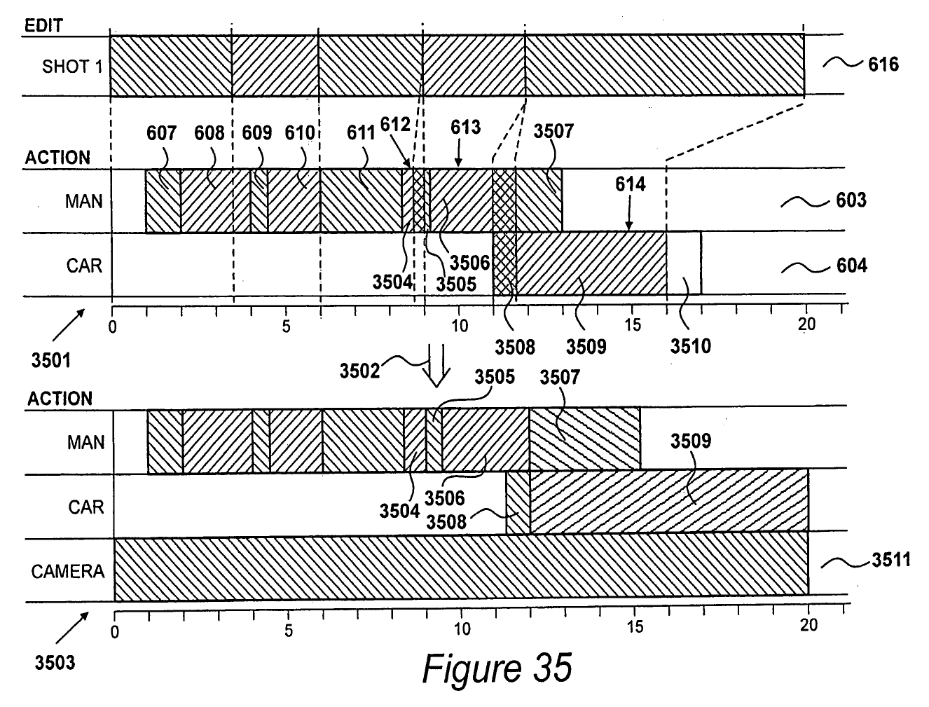

FIG. 35

FIG. 35 illustrates an example of the unwrapping process. The animation data contained in the Action timeline shown in FIG. 23 is shown generally at 3501, and the unwrapping process, indicated by arrow 3502, produces the unwrapped animation data 3503, also shown in the Action timeline. Shot channel 616 is also shown, although the Edit timeline is not.

The separate animation curves in channels 603 and 604 are shown. (Although the simplification process will create a single animation curve from these, the individual blocks are still shown at 3503 to facilitate understanding.) Curves 607, 608, 609, 610 and 611 fall within shots which have a one-to-one correlation between the Edit and Action timelines. However, a part of block 612 falls within two shots, and so this block has been split up into two sections 3504 and 3505 of different hatching, with the overlapping area indicating the area of repetition where animation will be copied. Similarly, block 613 is split into two sections 3506 and 3507. Additionally, curve 614 in animation channel 604 is split into three sections. Section 3509 entirely overlaps section 3508, and section 3510 is unhatched to indicate that it does not correspond to any shot in Edit and thus the animation data contained within would not be rendered in Edit mode. Note that sections 3504 to 3510 do not represent any kind of splitting of the animation curve but are merely for illustration purposes.

Animation data 3503 shows the unwrapped data. Sections 3504 and 3505 no longer overlap; instead the latter immediately follows the former. Section 3506 has also been moved along to the right, while section 3507 has been moved even further so that it does not overlap section 3506. It has also been stretched. Section 3508 has been moved, while section 3509 has also been moved so that it does not overlap section 3508 and has also been stretched. Section 3510 has been removed. A new camera channel 3511 has been added.

Thus it can be seen that the unwrapped animation data 3503 corresponds directly to the animation data in 3502 when played according to shot channel 616. It is therefore possible to export animation data (excluding any information regarding the Edit timeline), and when rendered it will be identical to the final version of the animation when played in Edit mode before unwrapping.

The unwrapping process herein described overwrites the previous animation data. However, the skilled reader will appreciate that the embodiment could be varied to allow the unwrapped data to be copied to a new project, rather than erasing the animation data in the project being modified.

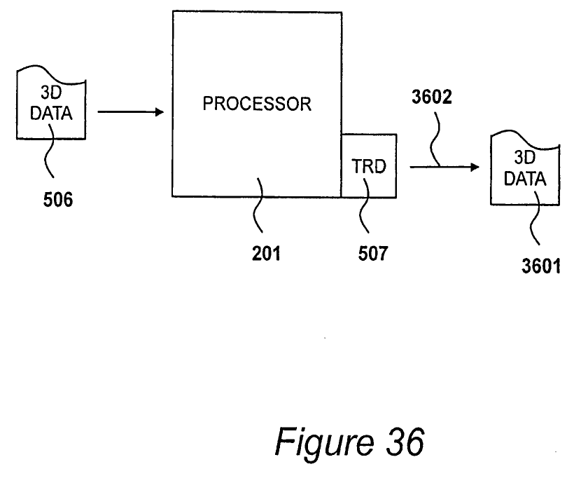

FIG. 36

FIG. 36 illustrates the unwrapping process in a block diagram. The 3D data 506 is provided as input to the processing system 201 which uses the time reference data 507 to produce new 3D data 3601, as shown by arrow 3602.

1. Apparatus for processing 3D data, comprising data storage means, memory means and processing means, wherein said 3D data is stored in said memory means and said processing means is configured to evaluate said 3D data with respect to a first function of time in a first evaluation mode and with respect to a second function of time in a second evaluation mode.

2. Apparatus according to claim 1, wherein the output values of said first function of time are identical to said input values.

3. Apparatus according to claim 1, wherein the output values of said second function of time are produced by transforming input values according to time reference data stored in said memory means.

4. Apparatus according to claim 1, further including manually-responsive input means, wherein an indication of said first or second evaluation state is received by said processing means via said input means.

5. Apparatus for processing 3D data, comprising data storage means, memory means and processing means wherein said memory means contains 3D data, and time reference data that provides a transformation between a first set of time references and a second set of time references; and wherein said processing means is configured to produce image data by performing the following steps:
receive an indication of a time reference;
transform said time reference according to said time reference data to obtain a transformed time reference; and
evaluate said 3D data with respect to said transformed time reference to obtain said image data.

6. Apparatus according to claim 5, wherein said apparatus includes visual display means and said processing means is further configured to output said image data to said visual display means.

7. Apparatus according to claim 5, wherein said processing means is further configured to store said image data in said data storage means.

8. Apparatus according to claim 5, wherein said 3D data includes assets and animation curves.

9. Apparatus according to claim 8, wherein said assets include set definitions, character definitions, animatable object definitions, camera definitions and light definitions.

10. Apparatus according to claim 9, wherein said step of evaluating said 3D data includes the steps of:
identifying a point of view;
evaluating the three-dimensional position and appearance of every asset in said 3D data at the time indicated by said transformed time reference; and
evaluating the position on a two-dimensional plane of every asset according to said point of view.

11. Apparatus according to claim 8, wherein said 3D data additionally comprises constraints on the animation of assets.

12. Apparatus for producing animated image data, comprising data storage means, memory means, processing means and visual display means, wherein said memory means contains 3D data, and time reference data that provides a transformation between a first set of time references and a second set of time references; and wherein said processing means is configured to produce image data by performing the following steps:
(a) obtaining a transformed time reference by transforming an input time reference using said time reference data;
(b) evaluating said 3D data with respect to said second time reference to produce image data;
(c) outputting said image data;
(d) processing said input time reference to produce a further time reference;
(e) repeating steps (a) to (d) a plurality of times, using said further time reference as said input time reference.

13. Apparatus according to claim 12, wherein said step of producing said further time reference comprises the following steps:
determining the time taken to perform steps (a) to (c), and
adding said time to said input time reference.

14. Apparatus according to claim 13, further comprising visual display means, wherein said image data is output to said visual display means.

15. Apparatus according to claim 12, wherein each step of producing said further time reference comprises adding a specified amount of time to said input time reference.

16. Apparatus according to claim 15, wherein said image data is output to said data storage means.

17. Apparatus for processing 3D data, comprising data storage means, memory means, processing means, manually-responsive input means and visual display means, wherein said memory means contains 3D data, and time reference data that provides a transformation between a first set of time references and a second set of time references; and wherein said processing means is configured to:
output to said visual display means a graphical user interface comprising a first timeline and a second timeline;
receive, via said manually-responsive input means, an indication of a first time reference on said first timeline;
evaluate said 3D data with respect to said first time reference to produce first image data;
receive, via said manually-responsive input means, an indication of a second time reference on said second timeline;
transform said second time reference, using said time reference data, to obtain a third time reference; and
evaluate said 3D data with respect to said third time reference to produce second image data.

18. Apparatus according to claim 17, wherein said time reference data further provides additional transformations between said second set of time references and said first set of time references; and wherein said processing means is further configured to:
transform said first time reference using one of said additional transformations to obtain a fourth time reference;
output to said visual display means a graphical user interface that displays said first time reference on said first timeline and said fourth time reference on said second timeline.

19. Apparatus according to claim 17, wherein said processing means is further configured to output to said visual display means a graphical user interface that displays said second time reference on said second timeline and said third time reference on said first timeline.

20. A method of producing image data, comprising the steps of:
receiving an indication of a time reference;
transforming said time reference according to a defined transformation to produce a transformed time reference; and
evaluating 3D data with respect to said transformed time reference to produce said image data.

21. A method according to claim 20, further comprising the step of displaying said image data.

22. A method according to claim 20, further comprising the step of exporting said image data.

23. A method according to claim 20, further including the steps of:
(a) producing a further time reference; and
(b) repeating said transformation and evaluation steps using said further time reference to produce further image data; and
(c) repeating steps (a) and (b) a plurality of times.

24. A method according to claim 23, wherein each further time reference is at an interval of one frame from the previous time reference.

25. A method of producing animated image data, comprising the steps of:
receiving an plurality of input values in a sequence, each representing a point in time;
processing said input values with modification data to produce a plurality of modified input values without modifying said sequence; and
sequentially processing said modified input values with input data to produce said animated image data.

26. Apparatus for processing 3D data, comprising data storage means, memory means and processing means, wherein said 3D data is stored in said memory means and said processing means is configured to produce image data by evaluating said 3D data with respect to a first function of time to produce first image data and with respect to a second function of time to produce second image data; wherein said processing means is further configured to process said 3D data to produce further 3D data, such that when said further 3D data is evaluated with respect to said first function of time the image data produced is substantially identical to said second image data.
